(19) United States
(12) Patent Application Publication
(10) Pub. No.: US 2024/0126019 A1
(43) Pub. Date: Apr. 18, 2024

(54) RECEPTION DEVICE, COMMUNICATION DEVICE, AND COMMUNICATION SYSTEM

(71) Applicant: NEC Corporation, Tokyo (JP)

(72) Inventors: Hisashi MIZUMOTO, Tokyo (JP); Fujio Okumura, Kanagawa (JP); Hiroshi Imai, Tokyo (JP)

(73) Assignee: NEC Corporation, Tokyo (JP)

(21) Appl. No.: 18/480,121

(22) Filed: Oct. 3, 2023

(30) Foreign Application Priority Data
Oct. 13, 2022 (JP) 2022-164680

(51) Int. Cl. G02B 6/32; G02B 6/42

(52) U.S. Cl. CPC G02B 6/32; G02B 6/4214

(57) ABSTRACT

A reception device includes a ball lens, a first light receiver including a first annular body surrounding a periphery of the ball lens, and light receiving units including first light receiving elements disposed on an inner peripheral side surface of the first annular body, and a second light receiver including a second annular body surrounding an outer periphery of the first annular body and second light receiving elements disposed on an outer peripheral side surface of the second annular body. The first light receiving elements are disposed on the inner peripheral side surface of the first annular body with the light receiving part facing the ball lens. The second light receiving elements are disposed on the outer peripheral side surface of the second annular body with the light receiving part facing in a direction opposite to the ball lens.

This application is based upon and claims the benefit of priority from Japanese Patent Application No. 2022-164680, filed on Oct. 13, 2022, the disclosure of which is incorporated herein in its entirety by reference.

### TECHNICAL FIELD

The present disclosure relates to a reception device and the like used for optical space communication.

### BACKGROUND ART

In optical space communication, optical signals (hereinafter, a spatial light signal) propagating in space are used for communication without via a medium such as an optical fiber. If the spatial light signal can be transmitted in a plurality of directions around the transmission device, a communication network using the spatial light signal can be constructed. In order to perform optical space communication with a communication device in an arbitrary direction, it is necessary to match transmission and reception directions of spatial light signals with the communication target. Patent Literature 1 (WO 2022/004106 A1) discloses a light receiving device that receives a spatial light signal. The device of Patent Literature 1 receives a spatial light signal condensed by a lens by a sensor array including a plurality of light receivers. The device of Patent Literature 1 selects the light receiver that receives the spatial light signal according to the integrated value of the voltage values of the electric signals derived from the spatial light signals received by the plurality of light receivers. The device of Patent Literature 1 collectively receives spatial light signals from a plurality of communication targets. The device of Patent Literature 1 efficiently receives the spatial light signals arriving from various directions by collectively distinguishing the transmission sources of the spatial light signals.

The plurality of light receivers constituting the sensor array of the device of Patent Literature 1 are disposed in an array on the same plane. The light receiving surfaces of the plurality of light receivers are oriented in the same direction. In the case of using the device of Patent Literature 1, since arrival directions of spatial light signals arriving from various directions cannot be detected, it is necessary to manually adjust the direction of the light receiving surface of the light receiver.

An object of the present disclosure is to provide a reception device and the like that can accurately detect arrival directions of spatial light signals arriving from various directions.

### SUMMARY

A reception device according to one aspect of the present disclosure includes a ball lens, a first light receiver including a first annular body surrounding a periphery of the ball lens, and a plurality of light receiving units including a plurality of first light receiving elements disposed on an inner peripheral side surface of the first annular body, and a second light receiver including a second annular body surrounding an outer periphery of the first annular body and a plurality of second light receiving elements disposed on an outer peripheral side surface of the second annular body. The plurality of first light receiving elements are disposed on the inner peripheral side surface of the first annular body with the light receiving part facing the ball lens. The plurality of second light receiving elements are disposed on the outer peripheral side surface of the second annular body with the light receiving part facing in a direction opposite to the ball lens.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a reception device according to a first example embodiment;

FIG. 2 is a conceptual diagram illustrating an example of a configuration of a receiver included in the reception device according to the first example embodiment;

FIG. 3 is a conceptual diagram illustrating an example of a configuration of a first light receiver included in the receiver included in the reception device according to the first example embodiment;

FIG. 4 is a conceptual diagram illustrating an example of a configuration of a second light receiver included in the receiver included in the reception device according to the first example embodiment;

FIG. 5 is a conceptual diagram for explaining a reception example of a spatial light signal arriving at the reception device of the first example embodiment;

FIG. 6 is a graph for explaining estimation of an arrival direction of the spatial light signal by the reception device according to the first example embodiment;

FIG. 7 is a conceptual diagram illustrating an example of a configuration of a communication control unit included in the reception device according to the first example embodiment;

FIG. 8 is a conceptual diagram illustrating an example of a configuration of a direction detection circuit included in the communication control unit of the reception device according to the first example embodiment;

FIG. 9 is a conceptual diagram illustrating an example of a configuration of a detection circuit included in a direction detection circuit included in the communication control unit of the reception device according to the first example embodiment;

FIG. 10 is a conceptual diagram illustrating an example of a configuration of a reception circuit included in the communication control unit of the reception device according to the first example embodiment;

FIG. 11 is a block diagram illustrating an example of a configuration of a communication device according to a second example embodiment;

FIG. 12 is a conceptual diagram illustrating an example of a configuration of the communication device according to the second example embodiment;

FIG. 13 is a conceptual diagram illustrating an example of a configuration of a receiver included in the communication device according to the second example embodiment;

FIG. 14 is a conceptual diagram illustrating an example of a moving mechanism of a light receiving unit included in the receiver of the communication device according to the second example embodiment;

FIG. 15 is a conceptual diagram illustrating an example of the moving mechanism of the light receiving unit included in the receiver of the communication device according to the second example embodiment;

FIG. 16 is a conceptual diagram illustrating an example of a position pattern for detecting the position of the light receiving unit included in the receiver of the communication device according to the second example embodiment;

FIG. 17 is a conceptual diagram illustrating an example of a configuration of an encoder that reads a position pattern for detecting the position of the light receiving unit included in the receiver of the communication device according to the second example embodiment;

FIG. 18 is a conceptual diagram illustrating an example of a configuration of a transmitter included in the communication device according to the second example embodiment;

FIG. 19 is a conceptual diagram illustrating an example of a configuration of a transmission unit included in the transmitter of the communication device according to the second example embodiment;

FIG. 20 is a conceptual diagram illustrating an example of an internal configuration of the transmission unit included in the transmitter of the communication device according to the second example embodiment;

FIG. 21 is a block diagram illustrating an example of a configuration of a communication control device of the communication device according to the second example embodiment;

FIG. 22 is a conceptual diagram for explaining a first scan signal transmitted by the transmitter of the communication device according to the second example embodiment;

FIG. 23 is a conceptual diagram for explaining an example in which the communication device according to the second example embodiment scans a first scan range;

FIG. 24 is a conceptual diagram illustrating a situation in which the communication device according to the second example embodiment is scanning a communication target;

FIG. 25 is a conceptual diagram illustrating a situation in which the communication device according to the second example embodiment has received the first scan signal from the communication target;

FIG. 26 is a conceptual diagram illustrating an example in which the communication device according to the second example embodiment changes the positions of the light receiving unit and the transmission unit;

FIG. 27 is a conceptual diagram for explaining an example in which the communication device according to the second example embodiment scans a second scan range;

FIG. 28 is a conceptual diagram illustrating a situation in which the communication device according to the second example embodiment has received a second scan signal from the communication target;

FIG. 29 is a conceptual diagram illustrating an example in which the communication device according to the second example embodiment changes the positions of the light receiving unit and the transmission unit;

FIG. 30 is a conceptual diagram for explaining an example in which the communication device according to the second example embodiment scans the second scan range;

FIG. 31 is a conceptual diagram illustrating a situation in which the communication device according to the second example embodiment transmits and receives the second scan signal to and from the communication target;

FIG. 32 is a conceptual diagram for explaining an example in which the communication device according to the second example embodiment scans a third scan range;

FIG. 33 is a conceptual diagram for explaining an example of a communication network according to an application example of the second example embodiment;

FIG. 34 is a conceptual diagram illustrating an example of a configuration of a reception device according to a third example embodiment; and

FIG. 35 is a block diagram illustrating an example of a hardware configuration that executes control and processing according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line.

### First Example Embodiment

First, a reception device according to the present example embodiment will be described with reference to the drawings. The reception device of the present example embodiment is used for optical space communication in which optical signals (hereinafter, also referred to as a spatial light signal) propagating in a space are transmitted and received without using a medium such as an optical fiber. The reception device of the present example embodiment may be used for applications other than optical space communication as long as the reception device receives light propagating in a space. In the present example embodiment, the spatial light signal is regarded as parallel light in order to arrive from a sufficiently distant position. The drawings used in the description of the present example embodiment are conceptual and do not accurately depict an actual structure.

### Configuration

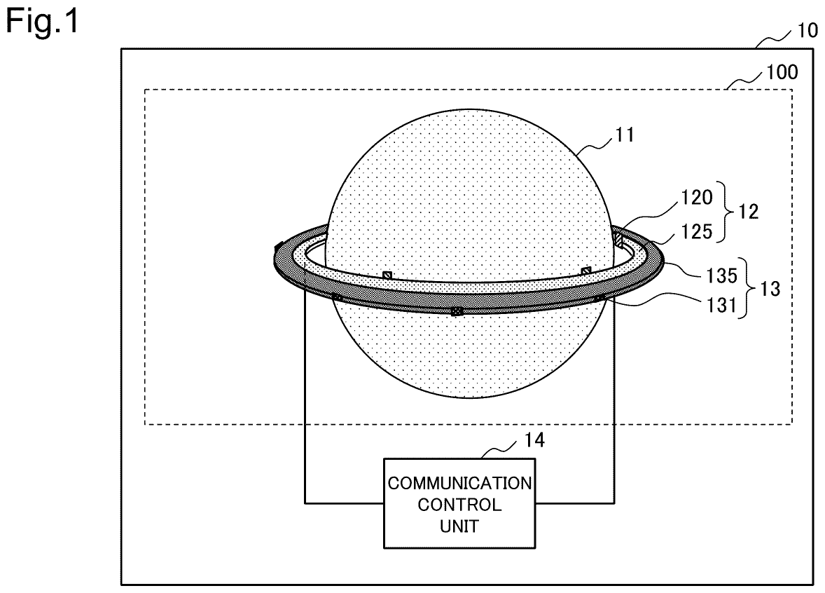

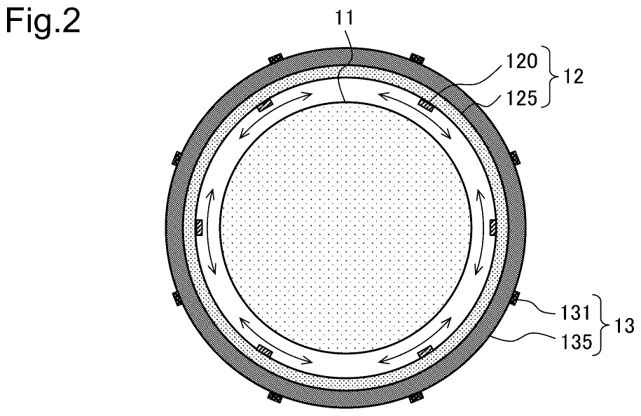

FIGS. 1 and 2 are conceptual diagrams illustrating an example of a configuration of a reception device 10 according to the present example embodiment. The reception device 10 includes a ball lens 11, a first light receiver 12, a second light receiver 13, and a communication control unit 14. The ball lens 11, the first light receiver 12, and the second light receiver 13 constitute a receiver 100. FIG. 1 is a diagram of the receiver 100 as viewed from an obliquely upper side. FIG. 2 is a conceptual diagram of the receiver 100 as viewed from an upper side.

A positional relationship among the ball lens 11, the first light receiver 12, and the second light receiver 13 is fixed by a support (not illustrated). In the present example embodiment, the support is omitted. The position of the communication control unit 14 is not particularly limited as long as there is no influence on the reception of the spatial light signal. For example, the communication control unit 14 is disposed on a support that supports the receiver 100.

The ball lens 11 is a spherical lens. The ball lens 11 is an optical element that collects a spatial light signal arriving from the outside. The ball lens 11 has a spherical shape when viewed from any angle. The ball lens 11 collects the incident spatial light signal. Light (also referred to as an optical signal) derived from the spatial light signal condensed by the ball lens 11 is condensed toward the condensing region of the ball lens 11. Since the ball lens 11 has a spherical shape, the ball lens collects a spatial light signal arriving from any direction. That is, the ball lens 11 exhibits similar light condensing performance for a spatial light signal arriving from any direction. The light incident on the ball lens 11 is refracted when entering the inside of the ball lens 11. The light traveling inside the ball lens 11 is refracted again when being emitted to the outside of the ball lens 11. Most of the light emitted from the ball lens 11 is condensed in the condensing region.

For example, the ball lens 11 can be made of a material such as glass, crystal, or resin. In the case of receiving a spatial light signal in the visible region, the ball lens 11 can be achieved by a material such as glass, crystal, or resin that transmits/refracts light in the visible region. For example, the ball lens 11 can be achieved by optical glass such as crown glass or flint glass. For example, the ball lens 11 can be achieved by a crown glass such as Boron Kron (BK). For example, the ball lens 11 can be achieved by a flint glass such as Lanthanum Schwerflint (LaSF). For example, quartz glass can be applied to the ball lens 11. For example, a crystal such as sapphire can be applied to the ball lens 11. For example, a transparent resin such as acrylic can be applied to the ball lens 11.

In a case where the spatial light signal is light in a near-infrared region (hereinafter, also referred to as near-infrared rays), a material that transmits near-infrared rays is used for the ball lens 11. For example, in a case of receiving a spatial light signal in a near-infrared region of about 1.5 micrometers (μm), a material such as silicon can be applied to the ball lens 11 in addition to glass, crystal, resin, and the like. In a case where the spatial light signal is light in an infrared region (hereinafter, also referred to as infrared rays), a material that transmits infrared rays is used for the ball lens 11. For example, in a case where the spatial light signal is an infrared ray, silicon, germanium, or a chalcogenide material can be applied to the ball lens 11. The material of the ball lens 11 is not limited as long as light in the wavelength region of the spatial light signal can be transmitted/refracted. The material of the ball lens 11 may be appropriately selected according to the required refractive index and use.

The first light receiver 12 includes a plurality of light receiving units 120 and a first annular body 125. The first annular body 125 has an annular shape. The first annular body 125 is disposed so as to surround the periphery of the ball lens 11. The plurality of light receiving units 120 are disposed on the inner peripheral side surface of the ring of the first annular body 125. The plurality of light receiving units 120 are disposed on the inner peripheral side surface of the first annular body 125 with their light receiving surfaces facing the ball lens 11. The plurality of light receiving units 120 are disposed such that the light receiving surfaces thereof are located in the condensing region of the ball lens 11. In the present example embodiment, the first light receiver 12 includes six light receiving units 120. In the example of FIG. 2, the six light receiving units 120 are disposed at the positions of the vertexes of the regular hexagon. The number of light receiving units 120 included in the first light receiver 12 is not particularly limited. The number of light receiving units 120 included in the first light receiver 12 may be set according to the number of communication targets or the like.

For example, the light receiving unit 120 is disposed to be movable along the circumferential direction of the first annular body 125 via a moving mechanism (not illustrated). With such a configuration, the light receiving unit 120 can be moved to a position with good light receiving efficiency according to the arrival direction of the spatial light signal.

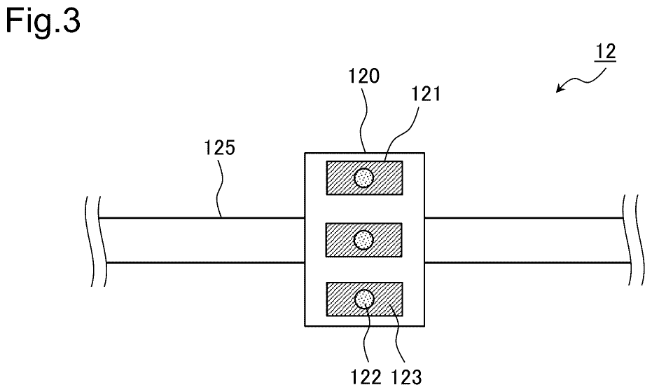

FIG. 3 is a conceptual diagram of a part of the first light receiver 12 as viewed from the ball lens 11. The light receiving unit 120 disposed on the inner peripheral side surface of the ring of the first annular body 125 includes a plurality of first light receiving elements 121. The first light receiving element 121 is used to receive the spatial light signal transmitted from the communication target. In the example of FIG. 3, the light receiving unit 120 includes three first light receiving elements 121 disposed in 3 rows×1 column. In a case where the heights of the reception device 10 and the communication target do not coincide with each other in the vertical direction, the arrival direction of the spatial light signal may be shifted in the vertical direction. When the plurality of first light receiving elements 121 are arranged along the vertical direction, it is possible to compensate for the deviation of the arrival direction of the spatial light signal in the vertical direction. The number of the first light receiving elements 121 included in the light receiving unit 120 is not limited to three. In a case where the deviation of the arrival direction of the spatial light signal cannot be compensated only by the three first light receiving elements 121, the number of first light receiving elements 121 may be four or more. For example, the plurality of first light receiving elements 121 may be disposed in an array including a plurality of columns. The types and the number of first light receiving elements 121 included in the plurality of light receiving units 120 may be the same or different. For example, the plurality of first light receiving elements 121 may be annularly disposed on the inner peripheral side surface of the ring of the first annular body 125. For example, the light receiving unit 120 may be disposed to be movable in the vertical direction with respect to the first annular body 125. For example, the first annular body 125 may be disposed so as to be movable in the vertical direction.

The first light receiving elements 121 included in the light receiving unit 120 are disposed with their light receiving surfaces facing the ball lens 11. The light receiving surface of the first light receiving element 121 faces the ball lens 11. The light receiving surface of the first light receiving element 121 includes a light receiving part 122 and a radio-quiet unit 123. The optical signal condensed by the ball lens 11 is incident on each of the plurality of first light receiving elements 121. The optical signal condensed on the light receiving part 122 is received by the first light receiving element 121. On the other hand, the optical signal condensed on the radio-quiet unit 123 is not received by the first light receiving element 121. Each of the plurality of first light receiving elements 121 converts the received optical signal into an electric signal. Each of the plurality of first light receiving elements 121 outputs the converted electric signal to the communication control unit 14.

The first light receiving element 121 receives light in a wavelength region of the spatial light signal to be received. For example, the first light receiving element 121 has sensitivity to light in the visible region. For example, the first light receiving element 121 has sensitivity to light in an infrared region. The first light receiving element 121 has sensitivity to light having a wavelength in a 1.5 μm (micrometer) band, for example. The wavelength band of light with which the first light receiving element 121 has sensitivity is not limited to the 1.5 μm band. The wavelength band of the light received by the first light receiving element 121 can be arbitrarily set in accordance with the wavelength of the spatial light signal transmitted from the transmission device (not illustrated). The wavelength band of the light received by the first light receiving element 121 may be set to, for example, a 0.8 μm band, a 1.55 μm band, or a 2.2 μm band. The wavelength band of the light received by the first light receiving element 121 may be, for example, a 0.8 to 1 μm band. A shorter wavelength band is advantageous for optical space communication during rainfall because absorption by moisture in the atmosphere is small. If the first light receiving element 121 is saturated with intense sunlight, the first light receiving element 121 cannot read the optical signal derived from the spatial light signal. Therefore, a color filter that selectively passes the light of the wavelength band of the spatial light signal may be installed at the preceding stage of the first light receiving element 121.

For example, the first light receiving element 121 can be achieved by an element such as a photodiode or a phototransistor. For example, the first light receiving element 121 is achieved by an avalanche photodiode. The first light receiving element 121 achieved by the avalanche photodiode can support high-speed communication. The first light receiving element 121 may be achieved by an element other than a photodiode, a phototransistor, or an avalanche photodiode as long as an optical signal can be converted into an electric signal. In order to improve the communication speed, the light receiving part of the first light receiving element 121 may be as small as possible. For example, the light receiving part of the first light receiving element 121 has a square light receiving surface having a side of about 5 mm (mm). For example, the light receiving part of the first light receiving element 121 has a circular light receiving surface having a diameter of about 0.1 to 0.3 mm The size and shape of the light receiving part of the first light receiving element 121 may be selected according to the wavelength band, the communication speed, and the like of the spatial light signal.

The second light receiver 13 includes a plurality of second light receiving elements 131 and a second annular body 135. The second light receiver 13 has an annular shape. The second annular body 135 is disposed so as to surround the outer peripheral side surface of the first annular body 125. As shown in FIGS. 1 and 2, the second annular body 135 has a larger diameter of the circular ring than the first annular body 125. That is, the diameter of the annular ring of the second annular body 135 is larger than the diameter of the annular ring of the first annular body 125. The diameter is not a specific diameter of a circular ring, but represents a relative magnitude relationship of sizes of rings formed by the first annular body 125 and the second annular body 135.

The second annular body 135 surrounds the outer periphery of the first annular body 125. The plurality of second light receiving elements 131 are disposed on the outer peripheral side surface of the ring of the second annular body 135. The second light receiving element 131 is used to specify the direction of the communication target that is the transmission source of the spatial light signal. The plurality of second light receiving elements 131 are disposed on the outer peripheral side surface of the second annular body 135 with their light receiving surfaces facing the opposite side of the ball lens 11. The plurality of second light receiving elements 131 are disposed such that the light receiving surface is perpendicular to the diametrical direction of the second annular body 135. In the present example embodiment, the second light receiver 13 includes eight second light receiving elements 131. For example, the eight second light receiving elements 131 are disposed at equal intervals. In the case of the example of FIG. 2, the eight second light receiving elements 131 are disposed at positions of vertexes of a regular octagon. The number of second light receiving elements 131 included in the second light receiver 13 is not particularly limited. The number of second light receiving elements 131 included in the second light receiver 13 may be set according to the number of communication targets or the like. When the number of second light receiving elements 131 is increased, the accuracy of the direction detection of the communication target is improved. The second light receiving element 131 disposed on the outer peripheral side surface of the ring of the second annular body 135 may be replaced with a light receiving unit (not illustrated) including a plurality of second light receiving elements 131. For example, the plurality of second light receiving elements 131 included in the light receiving unit may be disposed in an array including a plurality of rows and columns.

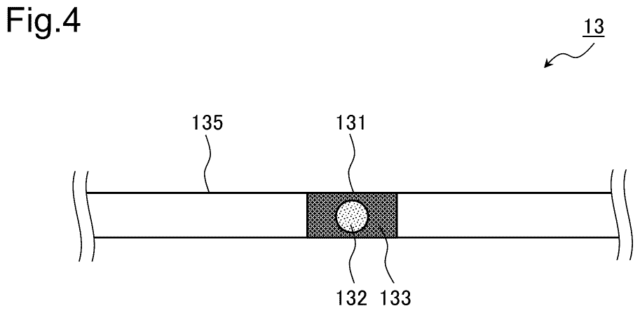

FIG. 4 is a conceptual diagram of a part of the second light receiver 13 as viewed from a side opposite to the ball lens 11. The light receiving surface of the second light receiving element 131 included in the second light receiver 13 includes a light receiving part 132 and a radio-quiet unit 133. The spatial light signal transmitted from the communication target is incident on each of the plurality of second light receiving elements 131. The optical signal condensed on the light receiving part 132 is received by the second light receiving element 131. On the other hand, the optical signal condensed on the radio-quiet unit 133 is not received by the second light receiving element 131. Each of the plurality of second light receiving elements 131 converts the received optical signal into an electric signal. Each of the plurality of second light receiving elements 131 outputs the converted electric signal to the communication control unit 14. The electric signal derived from the spatial light signal received by the second light receiver 13 is used for detecting the direction of the communication target.

Similarly to the first light receiving element 121, the second light receiving element 131 receives light in the wavelength region of the spatial light signal to be received. For example, the second light receiving element 131 has sensitivity to light in the visible region. For example, the second light receiving element 131 has sensitivity to light in an infrared region. The second light receiving element 131 has sensitivity to light having a wavelength in a 1.5 μm (micrometer) band, for example. The wavelength band of light with which the second light receiving element 131 has sensitivity is not limited to the 1.5 μm band. The wavelength band of the light received by the second light receiving element 131 can be arbitrarily set in accordance with the wavelength of the spatial light signal transmitted from the transmission device (not illustrated). The wavelength band of the light received by the second light receiving element 131 may be set to, for example, a 0.8 μm band, a 1.55 μm band, or a 2.2 μm band. The wavelength band of the light received by the second light receiving element 131 may be, for example, a 0.8 to 1 μm band. A shorter wavelength band is advantageous for optical space communication during rainfall because absorption by moisture in the atmosphere is small. If the second light receiving element 131 is saturated with intense sunlight, the light receiving element cannot read the optical signal derived from the spatial light signal. Therefore, a color filter that selectively passes the light of the wavelength band of the spatial light signal may be installed at the preceding stage of the second light receiving element 131.

For example, the second light receiving element 131 can be achieved by an element such as a photodiode or a phototransistor. For example, the second light receiving element 131 is achieved by an avalanche photodiode. The second light receiving element 131 achieved by the avalanche photodiode can support high-speed communication. The second light receiving element 131 may be achieved by an element other than a photodiode, a phototransistor, or an avalanche photodiode as long as an optical signal can be converted into an electric signal. In order to improve the communication speed, the light receiving part of the second light receiving element 131 may be as small as possible. For example, the light receiving part of the second light receiving element 131 has a square light receiving surface having a side of about 5 mm (mm). For example, the light receiving part of the second light receiving element 131 has a circular light receiving surface having a diameter of about 0.1 to 0.3 mm. The size and shape of the light receiving part of the second light receiving element 131 may be selected according to the wavelength band, the communication speed, and the like of the spatial light signal.

The communication control unit 14 acquires signals output from the plurality of second light receiving elements 131. The communication control unit 14 amplifies a signal from each of the plurality of second light receiving elements 131. The communication control unit 14 integrates the amplified signal. The communication control unit 14 performs analog-digital conversion (AD conversion) on the integrated signal. The communication control unit 14 separates the AD-converted signal into a frequency set for each communication target. The communication control unit 14 calculates the direction of the communication target using the output for each of the second light receiving elements 131 with respect to the frequency allocated for each communication target.

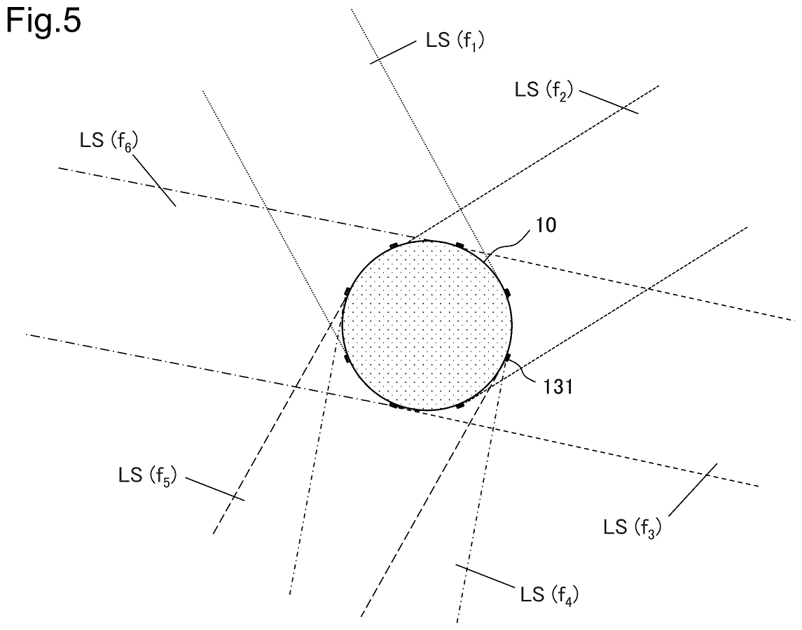

FIG. 5 is a conceptual diagram for explaining spatial light signals arriving at the reception device 10 from various directions. FIG. 5 illustrates a state in which the spatial light signal for search (scan signal LS) transmitted from the communication target arrives at the reception device 10 from six directions. The scan signals LS arriving from the six directions are transmitted from different communication targets. The scan signal LS is modulated at a specific frequency (f₁ to f₆) for each communication target. Each of the scan signals LS is received by the plurality of second light receiving elements 131. Depending on the arrival direction of the scan signal LS, the single second light receiving element 131 may simultaneously receive the scan signals LS from a plurality of communication targets.

The scan signal LS is received by the plurality of second light receiving elements 131. The intensity of the signal derived from the spatial light signal received by the second light receiving element 131 changes according to the arrival direction of the spatial light signal. As the spatial light signal is incident at an angle close to perpendicular to the light receiving surface of the second light receiving element 131, the intensity of the signal derived from the spatial light signal is larger. On the other hand, as the spatial light signal is incident on the light receiving surface of the second light receiving element 131 at an angle away from perpendicular, the intensity of the signal derived from the spatial light signal is smaller. Therefore, by comparing the intensities of the signals derived from the spatial light signals received by the plurality of second light receiving elements 131 with respect to the spatial light signal of a certain frequency, the arrival direction of the spatial light signal can be calculated.

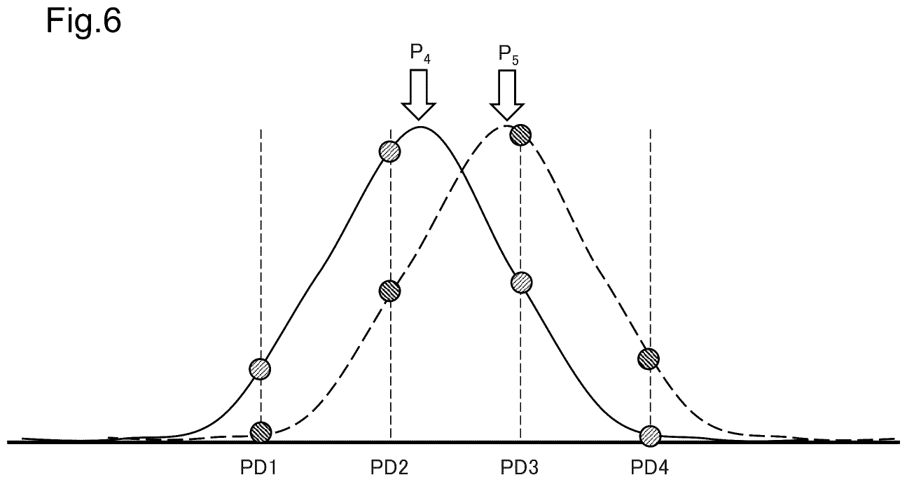

FIG. 6 is a graph for explaining an example of specifying the arrival direction of the scan signal LS. FIG. 6 illustrates an example of separating a scan signal LS₄ modulated at a frequency f₄ and a scan signal LS₅ modulated at a frequency f₅. The example of FIG. 6 illustrates an example in which the scan signal LS₄ and the scan signal LS₅ are received by the plurality of second light receiving elements 131 (PD1, PD2, PD3, PD4). In the example of FIG. 6, the scan signal LS is regarded as parallel light. The dot illustrated in FIG. 6 indicates the integrated intensity of the signal derived from the scan signal LS. A curve (solid line) indicates the intensity distribution of the scan signal LS₄ (frequency f₄). A curve (broken line) indicates the intensity distribution of the scan signal LS₅ (frequency f₅). FIG. 6 illustrates a maximum value P₄ of the intensity distribution of the scan signal LS₄ (frequency f 4) and a maximum value Ps of the intensity distribution of the scan signal LS₅ (frequency f₅). The direction in which the intensity of the scan signal LS indicates the maximum value corresponds to the arrival direction of the spatial light signal. As described above, in a case where the spatial light signals transmitted from the plurality of communication targets are simultaneously received, it is possible to specify the direction of the communication target that is the transmission source of the spatial light signals by separating the spatial light signals by the frequency. In a case where the second light receiving element 131 receives the scan signal LS of a single frequency, the direction of the communication target that is the transmission source can be specified according to the intensity distribution of the scan signal LS.

The communication control unit 14 changes the position of the light receiving unit 120 used to receive the spatial light signal transmitted by the communication target toward the specified communication target direction. The communication control unit 14 moves the light receiving unit 120 such that the light receiving surface of the light receiving unit 120 used for communication with the specified communication target faces the direction of the communication target. The spatial light signal transmitted from the communication target of which the direction is specified is condensed by the ball lens 11 and received by the light receiving unit 120 associated with the communication target.

The communication control unit 14 acquires signals output from the plurality of first light receiving elements 121. The communication control unit 14 amplifies a signal from each of the plurality of first light receiving elements 121. The communication control unit 14 decodes the amplified signal and analyzes a signal from the communication target. For example, the communication control unit 14 collectively analyzes the signals of the plurality of first light receiving elements 121 included in the same light receiving unit 120. In a case where the signals of the plurality of first light receiving elements 121 are collectively analyzed, it is possible to achieve the single-channel reception device 10 that communicates with a single communication target. For example, the communication control unit 14 is configured to individually analyze a signal for each of the first light receiving elements 121 included in the same light receiving unit 120. When a signal is analyzed for each of the first light receiving elements 121, it is possible to achieve the multi-channel reception device 10 that simultaneously communicates with a plurality of communication targets. The signal decoded by the communication control unit 14 is used for any purpose. The use of the signal decoded by the communication control unit 14 is not particularly limited.

### [Communication Control Unit]

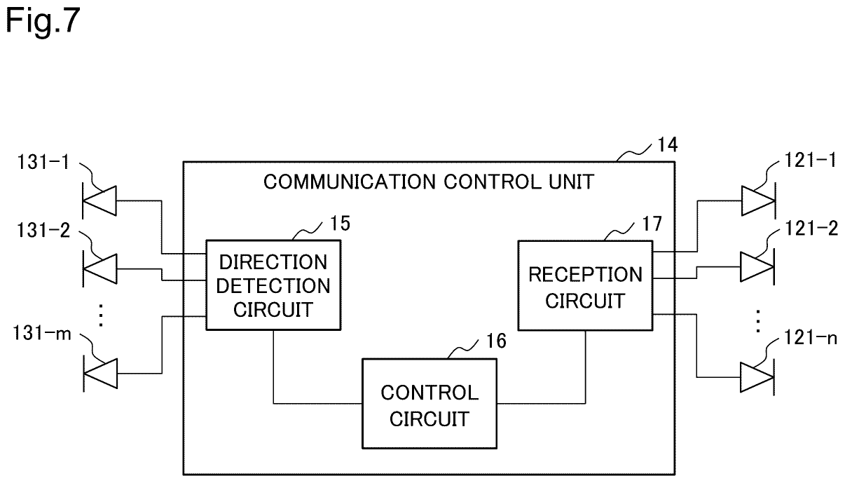

FIG. 7 is a conceptual diagram illustrating an example of a configuration of the communication control unit 14. The communication control unit 14 includes a direction detection circuit 15, a control circuit 16, and a reception circuit 17. FIG. 7 illustrates an example of the configuration of the communication control unit 14, and does not limit the configuration of the communication control unit 14.

The direction detection circuit 15 is connected to a plurality of second light receiving elements 131-1 to m (m is a natural number). The direction detection circuit 15 detects the arrival direction of the spatial light signal of the frequency according to the profile of the intensity for each frequency regarding the signals output from the plurality of second light receiving elements 131-1 to m. The direction detection circuit 15 outputs the detected arrival direction of the spatial light signal to the control circuit 16.

The control circuit 16 associates any of the plurality of light receiving units 120 with the frequency of the spatial light signal of which the arrival direction is specified. That is, a communication target is associated with the light receiving unit 120. The control circuit 16 moves the position of the light receiving unit 120 such that the light receiving surface of the light receiving unit 120 associated with the frequency of the spatial light signal faces the arrival direction of the spatial light signal. The control circuit 16 controls the reception circuit 17 so as to receive the optical signal received by the first light receiving element 121 included in the light receiving unit 120 with which the communication target is associated.

The reception circuit 17 receives a signal derived from the optical signal received by the first light receiving element 121. The reception circuit 17 receives a signal derived from the optical signal received by the first light receiving element 121 included in the light receiving unit 120 with which the communication target is associated. The reception circuit 17 decodes a signal for each light receiving unit 120.

### [Direction Detection Circuit]

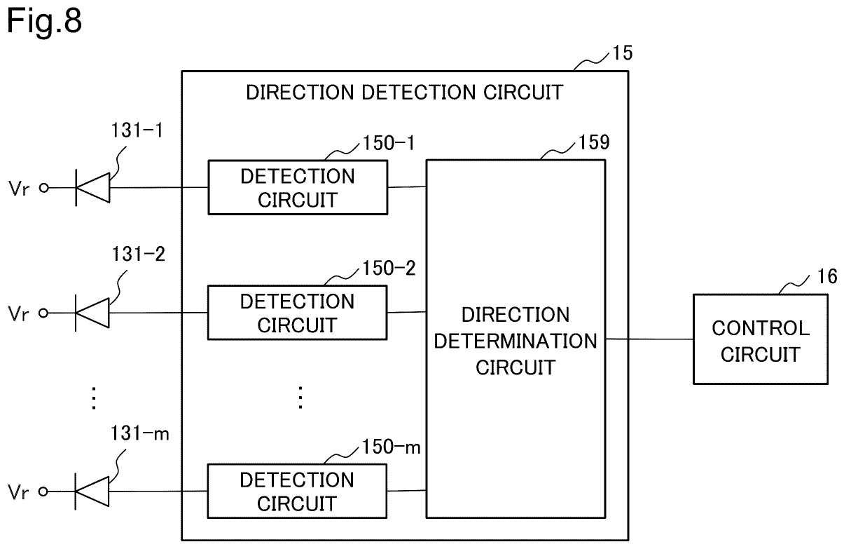

FIG. 8 is a conceptual diagram illustrating an example of a configuration of the direction detection circuit 15 included in the communication control unit 14. The direction detection circuit 15 includes a plurality of detection circuits 150-1 to m and a direction determination circuit 159. FIG. 8 is an example of the configuration of the direction detection circuit 15, and does not limit the configuration of the direction detection circuit 15.

Each of the plurality of detection circuits 150-1 to m is connected to each of the plurality of second light receiving elements 131-1 to m. The detection circuit 150 amplifies the signal from the second light receiving element 131. The detection circuit 150 integrates the amplified signal. The detection circuit 150 performs analog-digital conversion (AD conversion) on the integrated signal. The detection circuit 150 separates the AD-converted signal into a frequency set for each communication target.

The direction determination circuit 159 calculates the direction of the communication target according to the profile of each second light receiving element 131 related to the intensity of the frequency allocated to each communication target. The direction determination circuit 159 outputs the calculated direction of the communication target to the control circuit 16 in association with the frequency of the spatial light signal transmitted by the communication target.

### [Detection Circuit]

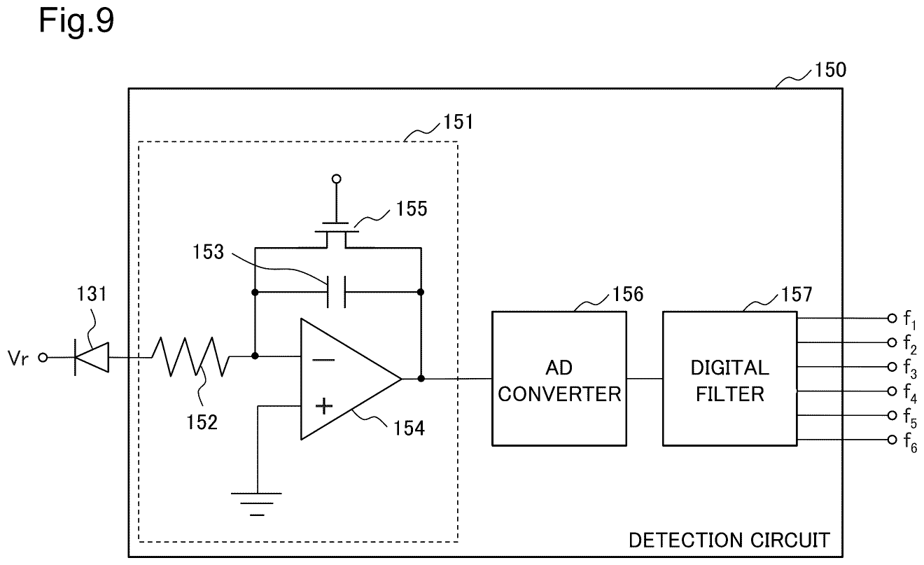

FIG. 9 is a conceptual diagram illustrating an example of a configuration of the detection circuit 150 included in the direction detection circuit 15. The detection circuit 150 includes an integrator 151, an AD converter 156, and a digital filter 157. The integrator 151 includes a resistor 152, a capacitor 153, an operational amplifier 154, and a switch 155. FIG. 9 illustrates an example of the configuration of the detection circuit 150, and does not limit the configuration of the detection circuit 150.

The first end (left side) of the resistor 152 is connected to the output of the second light receiving element 131. The second end (right side) of the resistor 152 is connected to the first end (left side) of the capacitor 153, the inverted input terminal (−) of the operational amplifier 154, and the first end (left side) of the switch 155.

The first end (left side) of the capacitor 153 is connected to the second end (right side) of the resistor 152, the first end (left side) of the capacitor 153, the inverted input terminal (−) of the operational amplifier 154, and the first end (left side) of the switch 155. The second end (right side) of the capacitor 153 is connected to the second end (right side) of the resistor 152, the second end (right side) of the capacitor 153, the output terminal (right side) of the operational amplifier 154, the second end (right side) of the switch 155, and the input end (left side) of the AD converter 156.

The inverted input terminal (−) of the operational amplifier 154 is connected to the second end (right side) of the resistor 152, the first end (left side) of the capacitor 153, and the first end (left side) of the switch 155. The non-inverted input terminal (+) of the operational amplifier 154 is grounded. The output end (right side) of the operational amplifier 154 is connected to the second end (right side) of the capacitor 153, the second end (right side) of the switch 155, and the input end (left side) of the AD converter 156.

The switch 155 is used to reset the charge accumulated in the capacitor 153. For example, the switch 155 is achieved by a field effect transistor (FET). The first end (left side) of the switch 155 is connected to the second end (right side) of the resistor 152, the first end (left side) of the capacitor 153, and the inverted input terminal (−) of the operational amplifier 154. The second end (right side) of the switch 155 is connected to the second end (right side) of the capacitor 153, the output end (right side) of the operational amplifier 154, and the input end of the AD converter 156. A voltage exceeding a gate threshold voltage is applied to the gate of the switch 155 under the control of the control circuit 16. When a voltage exceeding the gate threshold voltage is applied to the gate of the switch 155, the first end and the second end of the switch 155 are conducted, and the charge accumulated in the capacitor 153 is reset.

The AD converter 156 (also referred to as a converter) is connected to the output of the integrator 151. The AD converter 156 reads the signal output from the integrator 151 at a preset integration period. The AD converter 156 converts the read signal from analog to digital and cuts out the signal for each integration period. The AD converter 156 outputs the cut signal to the digital filter 157. Instead of the digital filter 157, an analog filter may be mounted on the detection circuit 150.

The digital filter 157 is connected to an output of the AD converter 156. The digital signal output from the AD converter 156 is input to the digital filter 157. The digital filter 157 separates the input digital signal into frequencies for communication targets. In the example of FIG. 9, the digital signal is separated into six frequencies (f₁, f₂, f₃, f₄, f₅, f₆). The digital filter 157 outputs the signal separated into the frequencies of the communication targets to the direction determination circuit 159.

### [Reception Circuit]

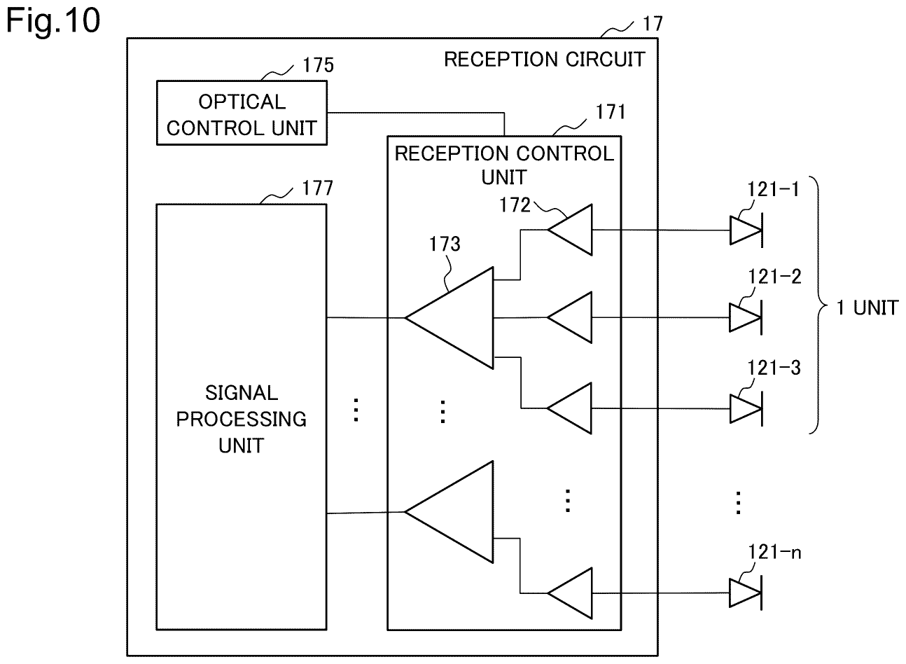

FIG. 10 is a block diagram illustrating an example of a configuration of the reception circuit 17. In the example of FIG. 10, the number of the plurality of first light receiving elements 121 is n (n is a natural number). The reception circuit 17 includes a reception control unit 171, an optical control unit 175, and a signal processing unit 177. FIG. 10 illustrates an example of the configuration of the reception circuit 17, and does not limit the configuration of the reception circuit 17.

The plurality of first light receiving elements 121-1 to n are connected to the reception control unit 171. Signals output from the plurality of first light receiving elements 121-1 to n are input to the reception control unit 171. The reception control unit 171 amplifies the input signal. The reception control unit 171 outputs the amplified signal to the signal processing unit 177.

In the example of FIG. 10, the reception control unit 171 includes a plurality of first amplifiers 172 and a plurality of second amplifiers 173. The first amplifier 172 is connected to any one of the plurality of first light receiving elements 121-1 to n. The first amplifier 172 amplifies the input signal. The first amplifier 172 outputs the amplified signal to the second amplifier 173. The plurality of first light receiving elements 121-1 to n are allocated to any one of the plurality of light receiving units 120. In the example of FIG. 10, one light receiving unit 120 includes three first light receiving elements 121. Each of the plurality of second amplifiers 173 is assigned to one of the light receiving units 120. The signals output from the plurality of first amplifiers 172 belonging to the assigned light receiving unit 120 are input to the second amplifier 173. The second amplifier 173 amplifies the input signal collectively for each light receiving unit 120. The second amplifier 173 outputs the signal amplified for each light receiving unit 120 to the signal processing unit 177. FIG. 10 illustrates an example of the configuration of the reception control unit 171, and does not limit the configuration of the reception control unit 171. For example, the reception control unit 171 may be configured to individually output the signals from the plurality of first light receiving elements 121-1 to n without collecting the signals for each light receiving unit 120.

For example, the reception control unit 171 may be provided with a high-pass filter or a band-pass filter (not illustrated). Light derived from sunlight is not modulated into a signal in a frequency band of a spatial light signal to be received even when converted into an electric signal. Therefore, if a high-pass filter or a band-pass filter is provided, a signal derived from ambient light such as sunlight is cut off, and a signal of a high-frequency component corresponding to a frequency band of a spatial light signal is selectively passed. For example, the reception control unit 171 may be provided with a band-pass filter (not illustrated).

The optical control unit 175 is connected to the reception control unit 171. The optical control unit 175 acquires an output value of the signal amplified by the reception control unit 171. The optical control unit 175 monitors the output value of the signal. For example, the optical control unit 175 may monitor outputs of the plurality of first amplifiers 172 and select the first amplifier 172 having a large output. The optical control unit 175 may monitor the signal intensity of the plurality of first light receiving elements 121 and select the first amplifier 172 connected to the first light receiving element 121 having a high signal intensity.

The signal processing unit 177 is connected to the reception control unit 171. The signal processing unit 177 acquires the signal amplified by the reception control unit 171. For example, the signal processing unit 177 acquires signals amplified collectively for each light receiving unit 120. For example, the signal processing unit 177 acquires a signal derived from an optical signal received by each of the plurality of first light receiving elements 121-1 to n. The signal processing unit 177 decodes the acquired signal. For example, the signal processing unit 177 applies some signal processing to the decoded signal. For example, the signal processing unit 177 outputs the decoded signal to an external signal processing device or the like (not illustrated).

As described above, the reception device according to the present example embodiment includes the ball lens, the first light receiver, the second light receiver, and the communication control unit. The ball lens is a spherical lens. The first light receiver includes a first annular body and a plurality of light receiving units. The first annular body surrounds the periphery of the ball lens. The light receiving unit includes a plurality of first light receiving elements disposed on an inner peripheral side surface of the first annular body. The plurality of first light receiving elements are disposed on the inner peripheral side surface of the first annular body with the light receiving part facing the ball lens. The second light receiver includes a second annular body and a plurality of second light receiving elements. The second annular body surrounds the outer periphery of the first annular body. The plurality of second light receiving elements are disposed on the outer peripheral side surface of the second annular body. The plurality of second light receiving elements are disposed on the outer peripheral side surface of the second annular body with the light receiving part facing in a direction opposite to the ball lens.

The communication control unit includes a direction detection circuit, a control circuit, and a reception circuit. The direction detection circuit detects the arrival direction of the spatial light signal according to the pattern of the intensity of the spatial light signal received by the plurality of second light receiving elements. The control circuit associates any one of the plurality of light receiving units with the spatial light signal of which the arrival direction is detected. The reception circuit decodes the optical signal received by the plurality of first light receiving elements included in the light receiving unit associated with the spatial light signal.

In the reception device of the present example embodiment, the plurality of second light receiving elements disposed on the outer peripheral side surface of the second annular body receives spatial light signals arriving from various directions. The reception device of the present example embodiment detects the arrival direction of the spatial light signal according to the pattern of the intensity of the spatial light signal received by the plurality of second light receiving elements. Therefore, according to the reception device of the present example embodiment, the arrival directions of spatial light signals arriving from various directions can be accurately detected.

In one aspect of the present example embodiment, the plurality of second light receiving elements are disposed at equal intervals on the outer peripheral side surface of the second annular body. According to the present aspect, the arrival directions of the spatial light signals arriving from various directions can be accurately detected by the spatial light signals received by the plurality of second light receiving elements disposed at equal intervals.

In one aspect of the present example embodiment, the plurality of light receiving units are disposed to be movable along the circumferential direction of the first annular body. The control circuit moves the position of the light receiving unit such that the light receiving surface of the light receiving unit associated with the spatial light signal faces the arrival direction of the spatial light signal. According to the present aspect, the light receiving surface of the light receiving unit can be automatically directed in the arrival direction of the spatial light signal transmitted from the communication target. Therefore, according to the present example embodiment, the light receiving efficiency of the spatial light signal transmitted from the communication target can be improved.

In one aspect of the present example embodiment, the direction detection circuit includes a plurality of detection circuits and a direction determination circuit. The detection circuit is associated with one of the plurality of second light receiving elements. The detection circuit integrates a signal derived from the spatial light signal received by the associated second light receiving element. The detection circuit separates the integrated signal into frequencies for communication targets. The direction determination circuit determines the arrival direction of the spatial light signal according to the profile of the signal for each frequency separated by the plurality of detection circuits. In the present aspect, the arrival direction of the spatial light signal is determined for each communication target according to the profile of the signal separated into the frequencies for each communication target. In this aspect, the detection accuracy of the spatial light signal is improved by integrating the signal derived from the spatial light signal. Therefore, according to the present aspect, the direction of the communication target can be accurately detected according to the arrival direction of the spatial light signal.

In an aspect of the present example embodiment, the detection circuit includes an integration circuit, a converter, and a digital filter. The integration circuit integrates a signal derived from the spatial light signal received by the associated second light receiving element. The converter converts the signal integrated by the integration circuit into a digital signal. The digital filter separates a signal converted into a digital signal by the converter into frequencies for communication targets. In the present aspect, the arrival direction of the spatial light signal is determined for each communication target according to the profile of the signal separated into the frequencies for each communication target. In this aspect, the detection accuracy of the spatial light signal is improved by integrating the signal derived from the spatial light signal. Therefore, according to the present aspect, the direction of the communication target can be accurately detected according to the arrival direction of the spatial light signal.

### Second Example Embodiment

Next, a communication device according to a second example embodiment will be described with reference to the drawings. The communication device of the present example embodiment includes the reception device according to the first example embodiment. The communication device of the present example embodiment includes a transmission device including a spatial light modulator.

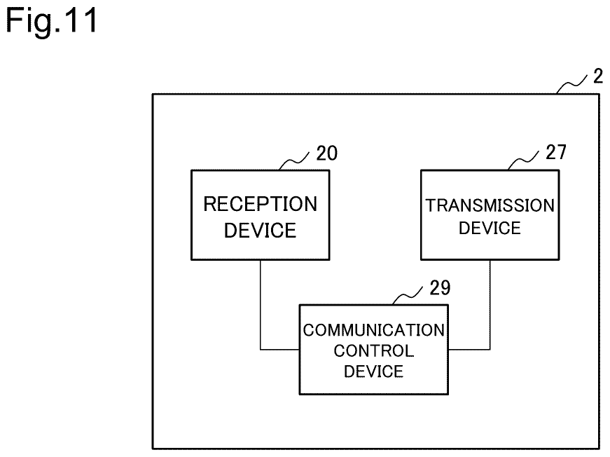

FIG. 11 is a block diagram illustrating an example of a configuration of a communication device 2 according to the present example embodiment. The communication device 2 includes a reception device 20, a transmission device 27, and a communication control device 29. The reception device 20 has the function of the receiver 100 included in the reception device 10 according to the first example embodiment. The function of the communication control unit 14 included in the reception device 10 according to the first example embodiment is implemented in the communication control device 29. The function of the communication control unit 14 included in the reception device 10 according to the first example embodiment may be implemented in the reception device 20.

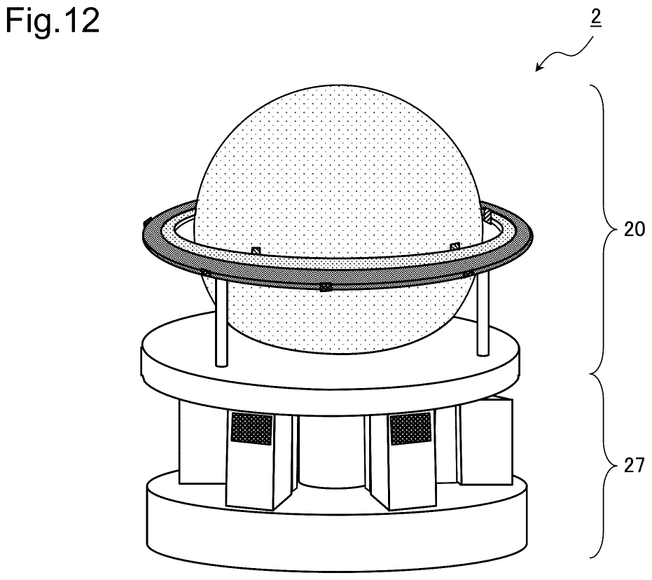

FIG. 12 is a conceptual diagram illustrating an example of a configuration of the communication device 2. FIG. 12 is a perspective view of the communication device 2. The reception device 20 is disposed to overlap the transmission device 27. The positional relationship between the reception device 20 and the transmission device 27 is not limited to the example of FIG. 12. For example, the reception device 20 may be disposed to overlap the transmission device 27. FIG. 12 does not illustrate the communication control device 29. The position of the communication control device 29 is not particularly limited as long as the reception of the spatial light signal is not affected. Hereinafter, the reception device 20, the transmission device 27, and the communication control device 29 will be individually described.

### [Receiver]

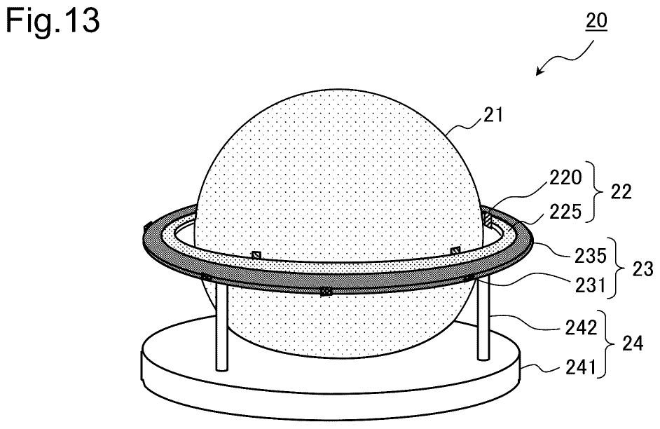

FIG. 13 is a conceptual diagram illustrating an example of a configuration of the reception device 20 included in the communication device 2. FIG. 13 is a diagram of the reception device 20 as viewed from an obliquely upper side. The reception device 20 includes a ball lens 21, a first light receiver 22, a second light receiver 23, and a support 24. The first light receiver 22 includes a plurality of light receiving units 220 and a first annular body 225. The second light receiver 23 includes a plurality of second light receiving elements 231 and a second annular body 235. The support 24 includes a support base 241 and a support column 242.

A positional relationship among the ball lens 21, the first light receiver 22, and the second light receiver 23 is fixed by the support 24. For example, the communication control device 29 is disposed in the support base 241. For example, the communication control device 29 disposed on the support base 241 is connected to the reception device 20 and the transmission device 27 via wiring (not illustrated) inside the support column 242. The ball lens 21, the first light receiver 22, and the second light receiver 23 have the same configurations as those of the first example embodiment. Hereinafter, the description of the same configuration as that of the first example embodiment will be omitted.

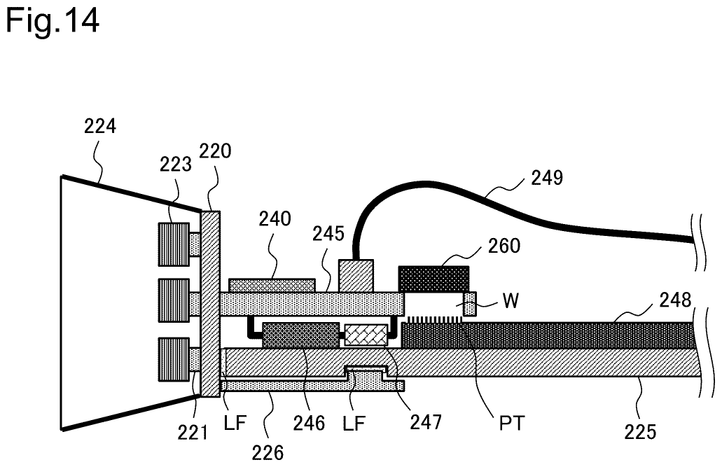

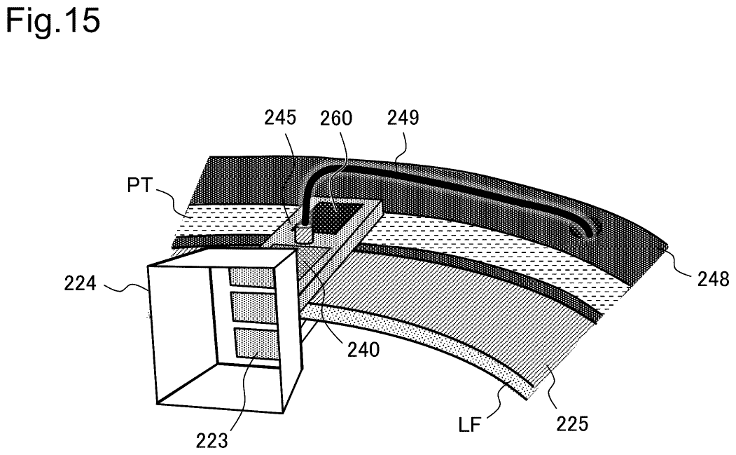

FIGS. 14 and 15 are conceptual diagrams for explaining an example of a moving mechanism that movably supports the light receiving unit 220 in the ring of the first annular body 225. FIG. 14 is a cross-sectional view of a portion including the light receiving unit 220 taken along the diametrical direction of the first annular body 225. FIG. 15 is a perspective view of the light receiving surface of the light receiving unit 220 as viewed from an upper side in the inner circle of the first annular body 225.

The light receiving unit 220 includes a plurality of first light receiving elements 221. A band pass filter 223 is disposed on the light receiving surface of each of the first light receiving elements 221. The band pass filter 223 selectively passes the wavelength of the spatial light signal to be received. A light shielding wall 224 is disposed on the light receiving surface of the light receiving unit 220. The light shielding wall 224 is disposed so as to surround the light receiving surface of the light receiving unit 220. The opening area of the light shielding wall 224 decreases toward the light receiving surface of the light receiving unit 220. For example, anti-scattering processing such as black paint is performed on the inner side of the light shielding wall 224 so that noise light is not included in the spatial light signal arriving at the light receiving surface of the light receiving unit 220. The light shielding wall 224 reduces irregular reflection of the spatial light signal arriving at the light receiving surface of the light receiving unit 220. The light shielding wall 224 prevents the spatial light signal arriving at the light receiving surface of a certain light receiving unit 220 from reaching the light receiving surface of another light receiving unit 220.

A first substrate 245 and a second substrate 248 are disposed on the upper surface of the first annular body 225. A reception circuit 240 is disposed on the upper surface of the first substrate 245. The reception circuit 240 may be disposed at a position different from the position illustrated in FIG. 14. The reception circuit 240 is connected to the communication control device 29 via a signal line 249.

The left end portion of the first substrate 245 is connected to the vicinity of the center of the light receiving unit 220. A tire 246 and a motor 247 are disposed below the first substrate 245. The rotation axis of the tire 246 is in the diametrical direction of the first annular body 225. The first substrate 245 is disposed so as to be movable on the upper surface of the first annular body 225 by the tire 246. The mechanism for driving the light receiving unit 220 may not include the tire 246 and the motor 247 as long as the light receiving unit 220 can move along the circumferential direction of the first annular body 225.

On the lower surface of the first annular body 225, a recessed track is formed along the circumferential direction of the first annular body 225. A fall prevention jig 226 is disposed below the first substrate 245 with the first annular body 225 interposed therebetween. On the upper portion of the fall prevention jig 226, a protrusion to be fitted into the track formed on the lower surface of the first annular body 225 is formed. A lubricating film LF is formed between the track on the lower surface of the first annular body 225 and the protrusion of the fall prevention jig 226. A left end portion of the fall prevention jig 226 is connected to a lower portion of the light receiving unit 220. The lubricating film LF is formed between the light receiving unit 220 and the first annular body 225.

The motor 247 is driven according to control by a control circuit (not illustrated). The tire 246 rotates in accordance with the drive of the motor 247. The first substrate 245 moves on the upper surface of the first annular body 225 along the circumferential direction of the first annular body 225 in accordance with the rotation of the tire 246. The orientation of the light receiving surface of the light receiving unit 220 changes according to the movement of the first substrate 245.

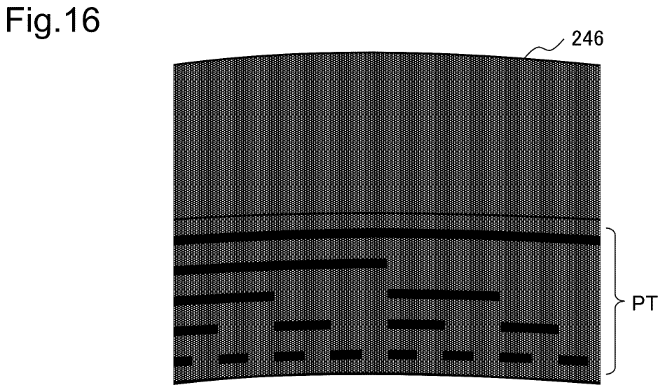

A position pattern PT is formed on the upper surface of the peripheral edge (left end) of the second substrate 248. The position pattern PT is a pattern for reading the position of the light receiving unit 220. FIG. 16 is a conceptual diagram illustrating an example of the position pattern PT. A window W opens at the right peripheral edge of the first substrate 245. The window W opens above the position pattern PT. An encoder 260 is disposed above the window W. The encoder 260 reads the position pattern PT and specifies the position of the light receiving unit 220.

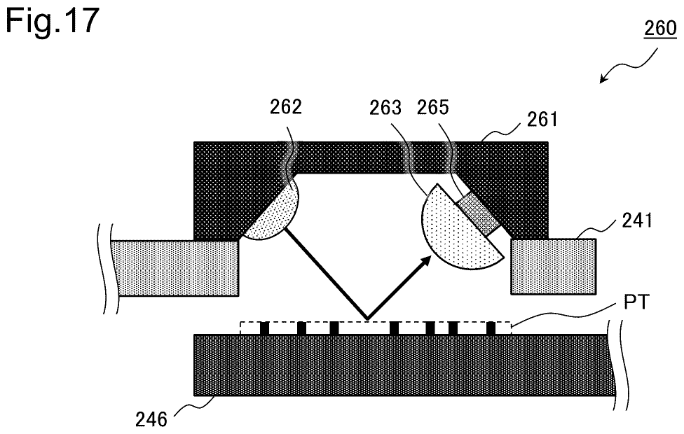

FIG. 17 is a conceptual diagram illustrating an example of a configuration of the encoder 260. FIG. 17 is a cross-sectional view of the encoder 260 taken along the diametrical direction of the first annular body 225. The encoder 260 includes a light source 262, a lens 263, and a light receiving element 265. The light source 262, the lens 263, and the light receiving element 265 are disposed on the lower surface of a housing 261 of the encoder 260. The light source 262 emits light for reading the position of the light receiving unit 220 toward the obliquely lower position pattern PT. The reflected light reflected at the position of the position pattern PT is condensed on the light receiving surface of the light receiving element 265 by the lens 263. The light receiving element 265 receives light collected by the lens 263. The light received by the light receiving element 265 is converted into an electric signal and output to a control circuit (not illustrated). The control circuit specifies the position of the light receiving unit 220 according to the pattern of the electric signal.

### [Transmitter]

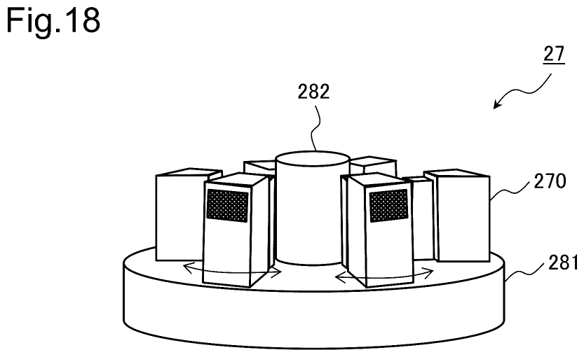

FIG. 18 is a conceptual diagram illustrating an example of a configuration of the transmission device 27. The transmission device 27 includes a plurality of transmission units 270. The plurality of transmission units 270 are disposed on the upper part of a movable table 281. The movable table 281 is a columnar table. The individual transmission units 270 are disposed to be movable along the circumferential direction of the columnar movable table 281. Detailed description of the moving mechanism of the upper surface of the movable table 281 is omitted. A support column 282 is disposed at the center of the upper surface of the movable table 281. The reception device 20 is disposed on an upper surface of the support column 282. For example, the transmission device 27 is connected to the communication control device 29 via a wiring disposed inside the support column 282.

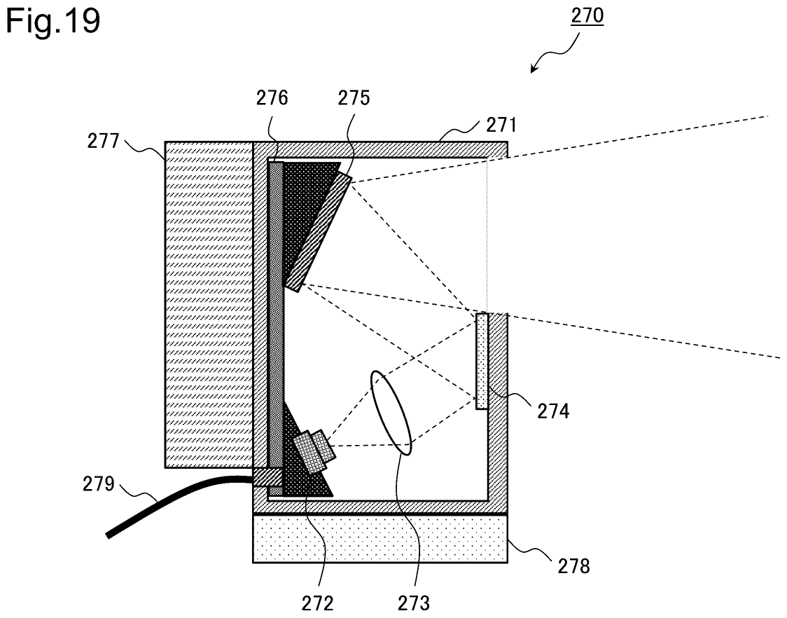

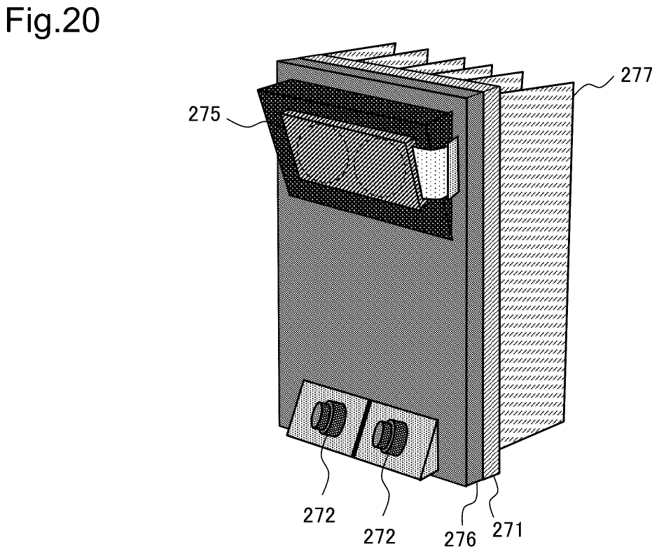

FIGS. 19 and 20 are conceptual diagrams for explaining the configuration of the transmission unit 270. FIG. 19 is a cross-sectional view illustrating the inside of a housing 271 of the transmission unit 270. In FIG. 19, an indication of the light path is indicated by a broken line. FIG. 20 is a perspective view illustrating an internal configuration of the housing 271 of the transmission unit 270. FIGS. 19 and 20 are conceptual, and do not accurately represent a positional relationship between components, a traveling direction of light, and the like.

The transmission unit 270 includes a light source 272, a collimator lens 273, a reflecting mirror 274, and a spatial light modulator 275. The light source 272, the collimator lens 273, the reflecting mirror 274, and the spatial light modulator 275 are disposed inside the housing 271 of the transmission unit 270. The light source 272 and the spatial light modulator 275 are fixed inside the housing 271 via a substrate 276. The light source 272 and the spatial light modulator 275 are connected to the communication control device 29 via a signal line 279 connected to the substrate 276. A heat sink 277 is disposed outside (on the left side) the housing 271. The heat sink 277 has a plurality of cooling fins. The heat sink 277 is a heat dissipation mechanism for releasing heat generated from the light source 272 and the spatial light modulator 275 to the outside. A moving mechanism 278 is disposed below the housing 271. The moving mechanism 278 supports the transmission unit 270 so as to be movable along the circumferential direction of the upper surface of the movable table 281.

The light source 272 emits light used for communication. In the example of FIG. 20, the transmission unit 270 includes two light sources 272. The number of light sources 272 included in the transmission unit 270 is not limited to two, and may be three or more, or may be one. The light source 272 emits light modulated according to a pattern of a signal to be transmitted to a communication target. The light emitted from the light source 272 is converted into parallel light (illumination light) by the collimator lens 273. The illumination light having passed through the collimator lens 273 is reflected by the reflecting surface of the reflecting mirror 274 and travels toward the modulation part of the spatial light modulator 275.

The light source 272 emits laser light of a predetermined wavelength band under the control of the communication control device 29. The wavelength of the laser light emitted from the light source 272 is not particularly limited, and may be selected according to the application. For example, the light source 272 emits the laser light in visible or infrared wavelength bands. For example, in the case of near-infrared rays of 800 to 900 nanometers (nm), the laser class can be given, and thus the sensitivity can be improved by about 1 digit as compared with other wavelength bands. For example, a high-power laser light source can be used for infrared rays in a wavelength band of 1.55 micrometers (μm). As a laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

The spatial light modulator 275 includes a modulation part. A modulation region is set in the modulation part. A pattern (also referred to as a phase image) corresponding to the image displayed by the projection light is set in the modulation region of the modulation part under the control of the communication control device 29. The modulation part is irradiated with the illumination light reflected by the reflecting surface of the reflecting mirror 274. In FIG. 20, the irradiation range of the illumination light with which the modulation part is irradiated is indicated by a broken line circle. The illumination light incident on the modulation part is modulated according to a pattern (phase image) set in the modulation part. The modulation light modulated by the modulation part is transmitted as a spatial light signal.

For example, the spatial light modulator 275 is achieved by a spatial light modulator using ferroelectric liquid crystal, homogeneous liquid crystal, vertical alignment liquid crystal, or the like. For example, the spatial light modulator 275 can be achieved by liquid crystal on silicon (LCOS). The spatial light modulator 275 may be achieved by a micro electro mechanical system (MEMS). In the spatial light modulator 275 of the phase modulation type, the energy can be concentrated on the portion of the image by operating to sequentially switch the portion on which the projection light is projected. Therefore, in the case of using the spatial light modulator 275 of the phase modulation type, if the output of the light source 272 is the same, the image can be displayed brighter than other methods.

The modulation region of the modulation part is divided into a plurality of regions (also referred to as tiling). For example, the modulation region of the modulation part is divided into rectangular modulation regions (also referred to as tiles) having a desired aspect ratio. A phase image is assigned to each of the plurality of tiles. Each of the plurality of tiles includes a plurality of pixels. A phase image relevant to a projected image is set to each of the plurality of tiles. The phase images set to the plurality of tiles may be the same or different.

A phase image is tiled to each of the plurality of tiles allocated to the modulation region of the modulation part. For example, a phase image generated in advance is set in each of the plurality of tiles. When the modulation part is irradiated with the illumination light in a state where the phase image is set in the plurality of tiles, the modulation light is emitted to form an image relevant to the phase image of each tile. As the number of tiles set in the modulation part increases, a clear image can be displayed. If the number of tiles set in the modulation part is too large, the number of pixels of each tile decreases, and the resolution decreases. Therefore, the size and number of tiles set in the modulation region of the modulation part are set according to the application.

For example, a curved minor may be disposed at a subsequent stage of the spatial light modulator 275. The curved mirror is a reflecting minor having the curved reflecting surface. The reflecting surface of the curved mirror has a curvature relevant to the projection angle of the projection light. The reflecting surface of the curved minor may be a curved surface. For example, the reflecting surface of the curved minor has a shape of a side surface of a cylinder. For example, the reflecting surface of the curved minor may be a free-form surface or a spherical surface. For example, the reflecting surface of the curved minor may have a shape in which a plurality of curved surfaces are combined instead of a single curved surface. For example, the reflecting surface of the curved minor may have a shape in which a curved surface and a flat surface are combined. The curved mirror is disposed with the reflecting surface facing the modulation part of the spatial light modulator 275. The curved minor is disposed on an optical path of the modulation light. The reflecting surface of the curved minor is irradiated with the modulation light modulated by the modulation part. The light (projection light) reflected by the reflecting surface of the curved minor is projected as a spatial light signal. The projection light is enlarged according to the curvature of the irradiation range of the modulation light on the reflecting surface of the curved minor. The transmission device 27 may be provided with a projection optical system including a Fourier transform lens, a projection lens, and the like instead of the curved mirror.

For example, a shield (not illustrated) may be disposed at a subsequent stage of the spatial light modulator 275. The shield is a frame that shields unnecessary light components included in the modulation light and defines an outer edge of a display region of the projection light. For example, the shield is an aperture. In such an aperture, a slit-shaped opening is formed in a portion through which light for forming a desired image passes. The shield passes light that forms a desired image and blocks unwanted light components. For example, the shield blocks 0th-order light or a ghost image included in the modulation light. Details of the shield will not be described.

### [Communication Control Device]

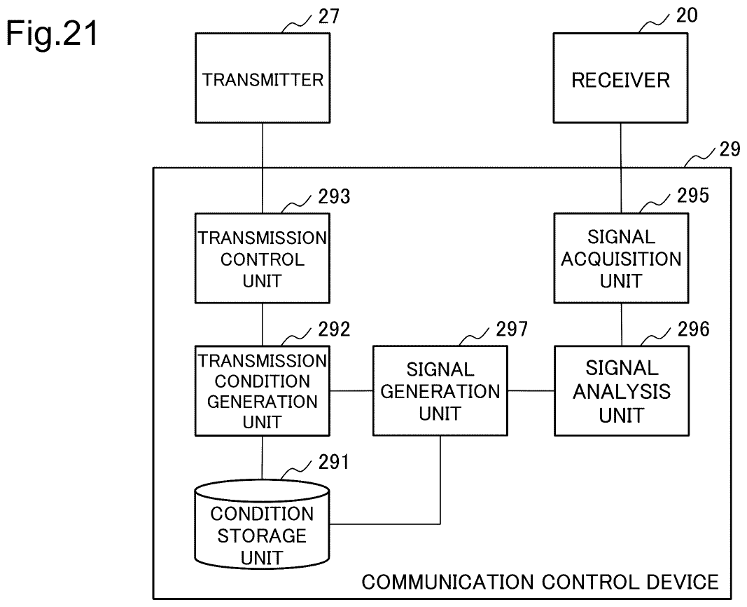

Next, a configuration of the communication control device 29 will be described with reference to the drawings. FIG. 21 is a block diagram for explaining an example of a configuration of the communication control device 29. The communication control device 29 includes a condition storage unit 291, a transmission condition generation unit 292, a transmission control unit 293, a signal acquisition unit 295, a signal analysis unit 296, and a signal generation unit 297. For example, the communication control device 29 is achieved by a microcomputer including a processor and a memory. For example, the communication control device 29 may be mounted on the reception device 20 and the transmission device 27. For example, the communication control device 29 may be mounted on a server or a cloud connected to the reception device 20 and the transmission device 27 via a network. FIG. 21 is an example of the configuration of the communication control device 29, and does not limit the configuration of the communication control device 29.

The condition storage unit 291 stores patterns such as a phase image, a shifted image, and a virtual lens image relevant to projection light (spatial light signal) to be transmitted to the transmission device 27. The pattern stored in the condition storage unit 291 is set in the modulation part of the spatial light modulator 275 of the transmission device 27. The condition storage unit 291 stores projection conditions including a light source control condition for controlling the light source 272 of the transmission device 27 and a modulator control condition for controlling the spatial light modulator 275 of the transmission device 27. The light source control condition is a condition including a timing at which the laser light is emitted from the light source 272 of the transmission device 27. The modulator control condition is a condition for setting a pattern in the modulation part of the spatial light modulator 275. By coordinating the light source control condition and the modulator control condition, projection light relevant to the pattern set in the modulation part of the spatial light modulator 275 is projected.

The transmission condition generation unit 292 acquires a signal from the signal generation unit 297. The transmission condition generation unit 292 generates a light transmission condition for transmitting information included in the acquired signal based on the condition stored in the condition storage unit 291. For example, the transmission condition generation unit 292 selects a pattern for transmitting the information included in the acquired signal based on the projection condition stored in the condition storage unit 291. For example, the transmission condition generation unit 292 generates a light transmission condition for setting a pattern relevant to an image projected for transmitting information included in the acquired signal to the modulation part of the spatial light modulator 275. For example, the transmission condition generation unit 292 generates the light transmission condition for setting the phase image relevant to the projected image in the modulation part of the spatial light modulator 275 in accordance with the aspect ratio of the modulation region set in the modulation part of the spatial light modulator 275.

The transmission control unit 293 outputs a light transmission instruction for controlling the light source 272 and the spatial light modulator 275 of the transmission device 27 to the transmission device 27 based on the light transmission condition set by the transmission condition generation unit 292.

The signal acquisition unit 295 acquires the signal decoded by the reception device 20 from the reception device 20. The signal acquisition unit 295 acquires the signal to which the signal processing has been applied by the reception device 20 from the reception device 20. For example, the signal acquired by the signal acquisition unit 295 includes a scanned communication target or a response transmitted from a communication target in communication according to the spatial light signal transmitted from the communication device 2. The signal acquisition unit 295 outputs the acquired signal to the signal analysis unit 296.

The signal analysis unit 296 analyzes the signal acquired by the signal acquisition unit 295. For example, the signal analysis unit 296 analyzes information included in a signal according to the type of signal. For example, the type of signal includes a scan signal and a communication signal. The scan signal is a signal used for searching for a communication target. The communication signal is a signal used for communication with the searched communication target. The type of signal analyzed by the signal analysis unit 296 is not particularly limited. The signal analysis unit 296 outputs an analysis result of the signal to the signal generation unit 297.

The signal generation unit 297 acquires an analysis result of the signal by the signal analysis unit 296. The signal generation unit 297 generates a transmission signal according to an analysis result of the signal. The transmission signal includes a communication content with the communication target and a content used for scanning the communication target. The signal generation unit 297 generates a transmission signal for each communication target. The signal generation unit 297 outputs the generated signal to the transmission condition generation unit 292.

The communication control device 29 detects the arrival direction of the spatial light signal according to the intensity pattern of the spatial light signal received by the plurality of second light receiving elements 231. The communication control device 29 associates any one of the plurality of light receiving units 220 with the spatial light signal of which the arrival direction is detected. The communication control device 29 moves the position of the light receiving unit 220 such that the light receiving surface of the light receiving unit 220 associated with the spatial light signal faces the arrival direction of the spatial light signal. The communication control device 29 decodes the optical signals received by the plurality of first light receiving elements 221 included in the light receiving unit 220 associated with the spatial light signal. These processes may be executed by the reception circuit 240.

### [Communication Establishment]

Next, an example of establishment of communication with a communication target by the communication device 2 will be described with reference to the drawings. Here, establishment of communication between a communication device 2A and a communication device 2B will be described with an example. The following communication establishment is an example, and does not limit the communication establishment by the communication device 2 of the present example embodiment.

The communication device 2 executes different processing in a first scan mode, a second scan mode, and a communication mode. The first scan mode is a mode for transmitting a first scanning spatial light signal (first scan signal LS₁) and searching for a communication target. In the first scan mode, the communication device 2 detects the position of the communication target using the optical signals received by the plurality of second light receiving elements 231 included in the second light receiver 23. The second scan mode is a mode in which a second scanning spatial light signal (second scan signal LS₂) is transmitted in response to reception of the first scan signal transmitted from a communication target, and communication with the communication target is established. In the second scan mode, the communication device 2 specifies the accurate position of the communication target using the optical signals received by the plurality of first light receiving elements 221 included in the first light receiver 22. The communication mode is a mode in which spatial light signals (communication signals) modulated for communication are transmitted and received to and from a communication target for which communication is established, and mutual communication is performed.

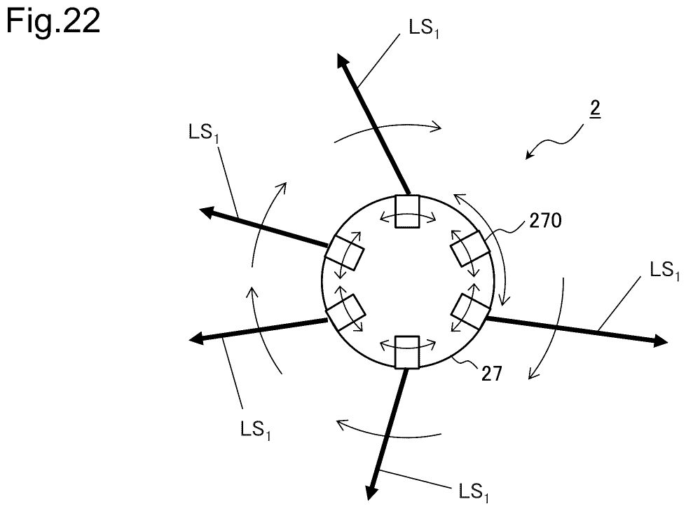

FIG. 22 is a conceptual diagram illustrating an example in which the transmission device 27 of the communication device 2 transmits the first scan signal LS₁ in the first scan mode. FIG. 22 is a diagram of the communication device 2 viewed from an upper side. The first scan signal LS₁ is modulated at a frequency unique to the communication device 2. FIG. 22 illustrates the transmission unit 270 included in the transmission device 27. The transmission unit 270 scans the communication target by changing the transmission direction of the first scan signal LS₁. In a case where the communication target cannot be scanned only by changing the transmission direction of the first scan signal LS₁, the communication device 2 changes the position of the transmission unit 270 and performs scanning again. For example, the first scan signal LS₁ may not be transmitted for the transmission unit 270 relevant to the direction in which it is known in advance that there is no communication target. Hereinafter, the first scan signal LS₁ transmitted by the communication device 2A is referred to as LS_{1A}. Similarly, the first scan signal LS₁ transmitted by the communication device 2B is denoted as LS_{1B}.

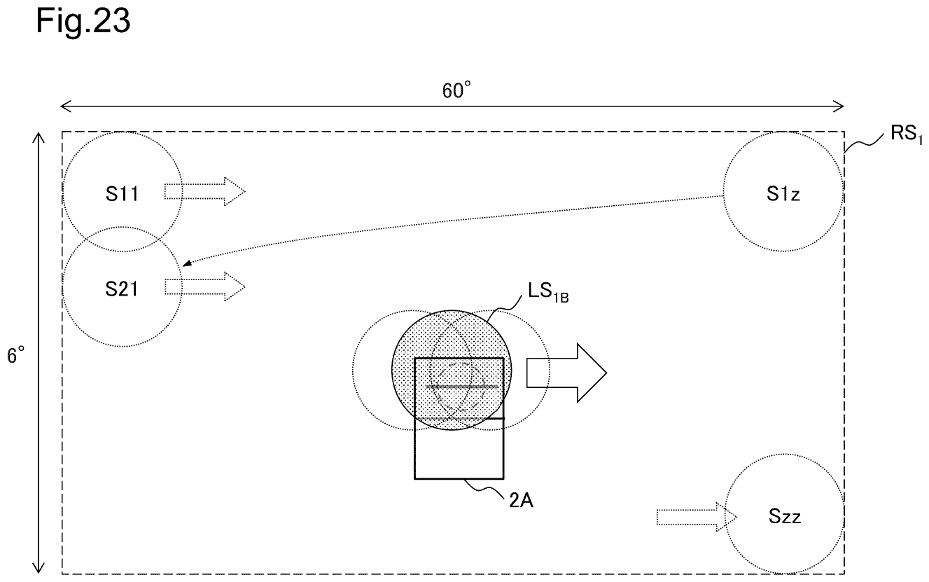

FIG. 23 is a conceptual diagram for explaining an example in which the communication device 2 scans a first scan range RS₁ in the first scan mode. The first scan range RS₁ is a transmission range of the first scan signal LS₁. The first scan signal LS₁ is a spatial light signal for notifying the communication target of the position of the communication device 2. FIG. 23 illustrates the first scan range RS₁ of the communication device 2B. In the present example embodiment, six transmission units 270 are used to scan a range of 360 degrees in a horizontal plane. FIG. 23 is the first scan range RS₁ of a single transmission unit 270. In the example of FIG. 23, the first scan range RS₁ of the single transmission unit 270 has 60 degrees in the horizontal direction and 6 degrees in the vertical direction. FIG. 23 is an example, and the first scan range RS₁ of the communication device 2 can be arbitrarily set.

As illustrated in FIG. 23, the communication device 2B changes the transmission direction of a first scan signal LS_{1B} in the first scan range RS₁. In the example of FIG. 23, the communication device 2B changes the transmission direction of the first scan signal LS_{1B} from the upper left irradiation range S11 of the first scan range RS₁ as a start point toward the right side in the horizontal direction. When the transmission direction of the first scan signal LS_{1B} reaches an irradiation range S1z at the right end of the first scan range RS₁, the communication device 2B moves the transmission direction of the first scan signal LS_{1B} to an irradiation range S21 at the left end of the first scan range RS₁ (z is a natural number). In this manner, the communication device 2B changes the transmission direction of the first scan signal LS_{1B}. For example, in a case where there is no response from the communication target at the stage of reaching an irradiation range Szz at the lower right of the first scan range RS₁, the communication device 2B changes the position of the transmission unit 270. FIG. 23 illustrates a state in which the first scan signal LS_{1B} transmitted from the communication device 2B reaches the communication device 2A that is a communication target of the communication device 2B.

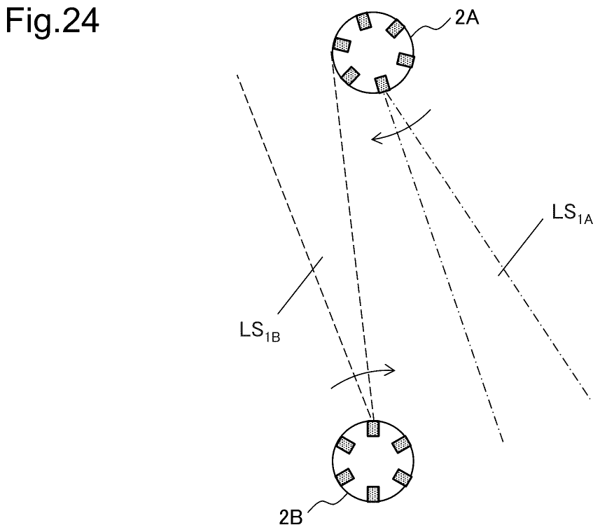

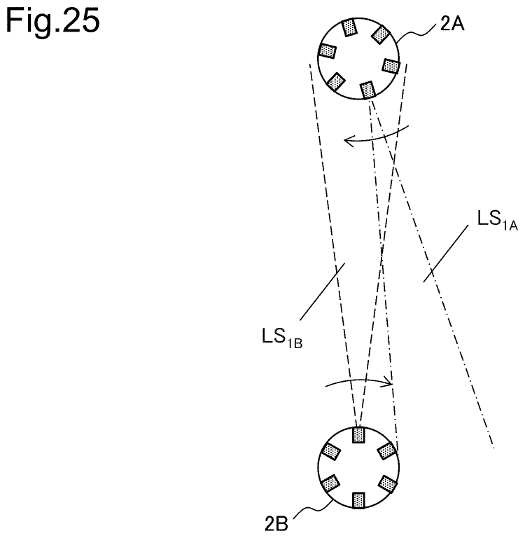

FIGS. 24 and 25 illustrate a state in which the communication device 2A and the communication device 2B are scanning the communication target. The communication device 2A transmits a first scan signal LS_{1A}. The communication device 2B transmits a first scan signal LS_{1B}. At the stage of FIG. 24, neither the communication device 2A nor the communication device 2B receives the first scan signal LS₁ transmitted from the communication target. Therefore, in the stage of FIG. 24, the communication device 2A and the communication device 2B do not specify each other's directions.

In the stage of FIG. 25, the communication device 2B does not receive the first scan signal LS_{1A} transmitted from the communication device 2A. On the other hand, in the stage of FIG. 25, the communication device 2A receives the first scan signal LS_{1B} transmitted from the communication device 2B. Therefore, at the stage of FIG. 25, the communication device 2A can detect the direction of the communication device 2B.

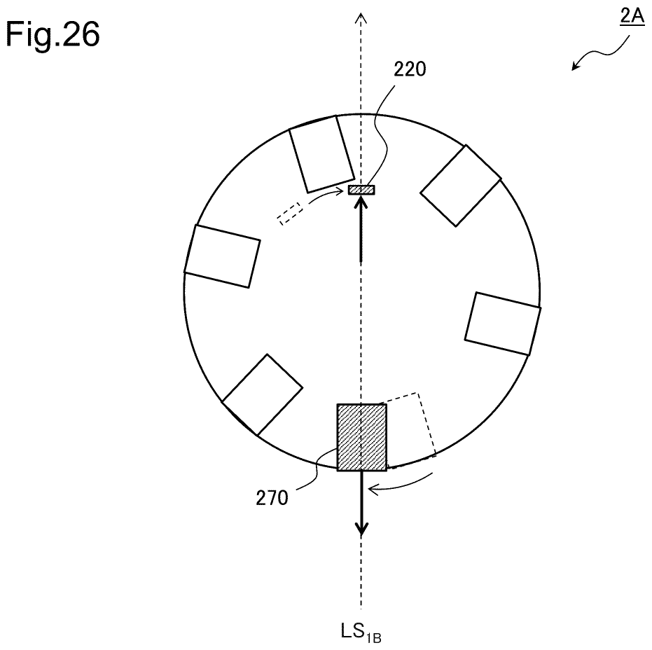

FIG. 26 is a conceptual diagram illustrating an example in which the communication device 2A transitions from the first scan mode to the second scan mode in response to reception of the first scan signal LS_{1B} transmitted from the communication device 2B. In response to the reception of the first scan signal LS_{1B}, the communication device 2A stops the transmission of the first scan signal LS_{1A} and calculates the arrival direction of the first scan signal LS_{1B}. The communication device 2A changes the positions of the light receiving unit 220 and the transmission unit 270 in accordance with the calculated arrival direction of the first scan signal LS_{1B}. As illustrated in FIG. 26, the communication device 2A directs the light receiving surface of the light receiving unit 220 in the arrival direction of the first scan signal LS_{1B}. The communication device 2A directs the transmission direction of the spatial light signal by the transmission unit 270 to the arrival direction of the first scan signal LS_{1B}. The communication device 2A transmits a spatial light signal (second scan signal LS₂) for establishing communication toward the arrival direction of the first scan signal LS_{1B}. Hereinafter, the second scan signal LS₂ transmitted by the communication device 2A is referred to as LS_{2A}. Similarly, the second scan signal LS₂ transmitted by the communication device 2B is referred to as LS_{2B}.

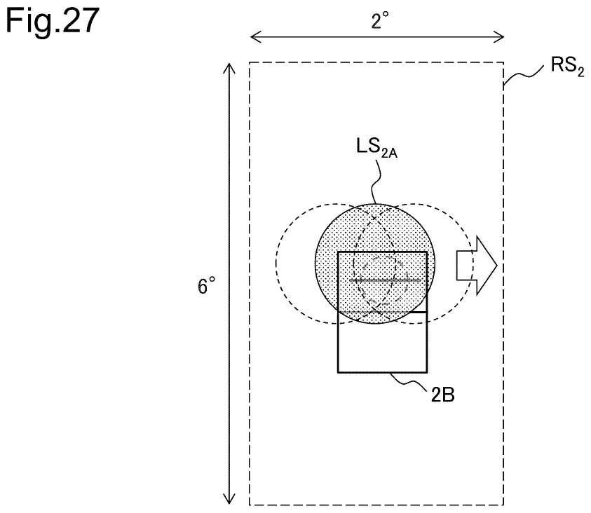

FIG. 27 is a conceptual diagram for explaining an example in which the communication device 2A scans a second scan range RS₂ in the second scan mode. The second scan range RS₂ is a transmission range of the second scan signal LS₂. In response to the reception of the first scan signal LS₁, the second scan signal LS₂ is a signal for notifying the communication target of the transmission source of the first scan signal LS₁ of the position of the communication device 2. FIG. 27 illustrates the second scan range RS₂ of the communication device 2A. The second scan range RS₂ is a range narrowed in accordance with the direction of the communication device 2B. In the example of FIG. 27, the second scan range RS₂ has 2 degrees in the horizontal direction and 6 degrees in the vertical direction.

As illustrated in FIG. 27, the communication device 2A that has received the first scan signal LS_{1B} from the communication device 2B changes the transmission direction of the second scan signal LS_{2A} in the second scan range RS₂. Similarly to the example of FIG. 23, the communication device 2A changes the transmission direction of the second scan signal LS_{2A} from the upper left irradiation range of the second scan range RS₂ as a start point toward the right side in the horizontal direction. When the transmission direction of the second scan signal LS_{2A} reaches the irradiation range at the right end of the second scan range RS₂, the communication device 2A moves the transmission direction of the second scan signal LS_{2A} to the irradiation range at the left end of the second scan range RS₂. As described above, while sequentially changing the transmission direction of the second scan signal LS_{2A}, the communication device 2A specifies the accurate direction of the communication target.

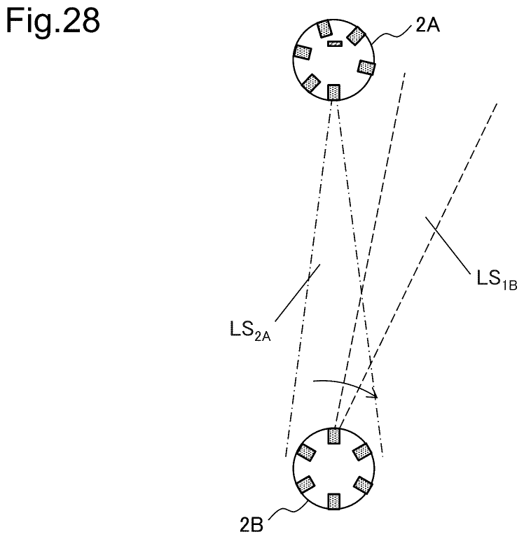

FIG. 28 is a conceptual diagram illustrating a state in which the communication device 2A transmits the second scan signal LS_{2A} to the communication device 2B. In the stage of FIG. 28, the communication device 2B detects that the first scan signal LS_{1B} transmitted from the communication device 2B itself is received by the communication device 2A. Therefore, at the stage of FIG. 28, the communication device 2B still transmits the first scan signal LS_{1B}.

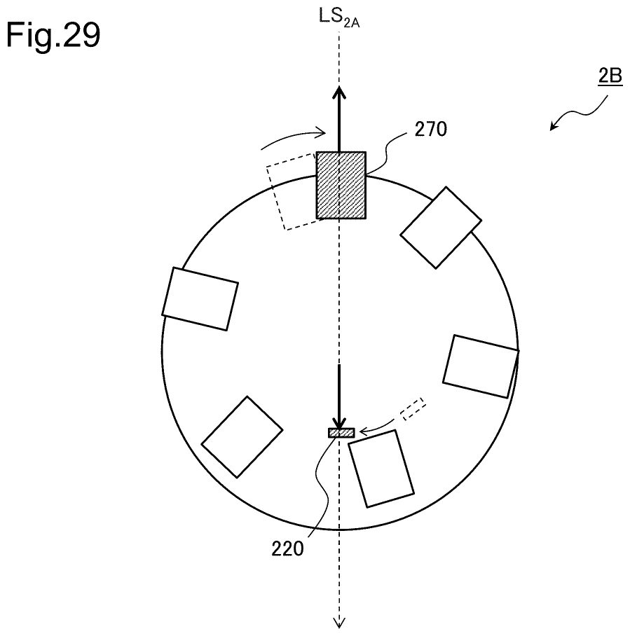

FIG. 29 is a conceptual diagram illustrating an example in which the communication device 2B transitions from the first scan mode to the second scan mode in response to reception of the second scan signal LS_{2A} transmitted from the communication device 2A. In response to the reception of the second scan signal LS_{2A}, the communication device 2B stops transmitting the first scan signal LS_{1B} and calculates the arrival direction of the second scan signal LS_{2A}. The communication device 2B changes the positions of the light receiving unit 220 and the transmission unit 270 in accordance with the calculated arrival direction of the second scan signal LS_{2A}. As illustrated in FIG. 29, the communication device 2B directs the light receiving surface of the light receiving unit 220 in the arrival direction of the second scan signal LS_{2A}. The communication device 2B directs the transmission direction of the spatial light signal by the transmission unit 270 to the arrival direction of the second scan signal LS_{2A}. The communication device 2B transmits a spatial light signal (second scan signal LS₂) for establishing communication.

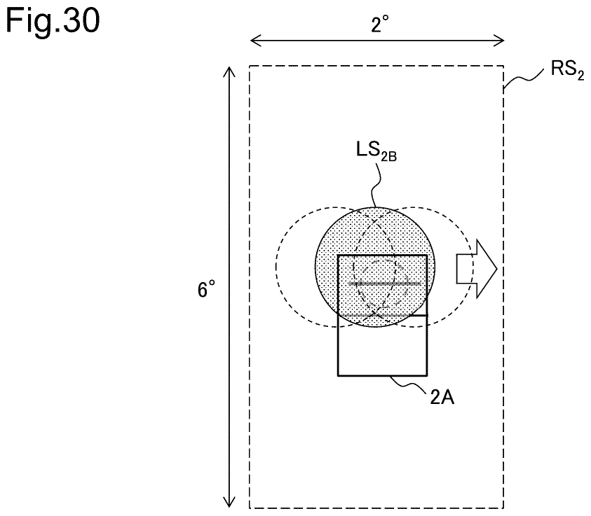

FIG. 30 is a conceptual diagram for explaining an example in which the communication device 2B scans the second scan range RS₂ in the second scan mode. The second scan range RS₂ is a transmission range of the second scan signal LS₂. In the case of FIG. 30, in response to the reception of the second scan signal LS₂, the second scan signal LS₂ is a signal for notifying the communication target of the transmission source of the second scan signal LS₂ of the position of the communication device 2. FIG. 30 illustrates the second scan range RS₂ of the communication device 2B. The second scan range RS₂ is a range narrowed in accordance with the direction of the communication device 2A. In the example of FIG. 30, the second scan range RS₂ has 2 degrees in the horizontal direction and 6 degrees in the vertical direction.

As illustrated in FIG. 30, the communication device 2B that has received the second scan signal LS_{2A} from the communication device 2A changes the transmission direction of the second scan signal LS_{2A} in the second scan range RS₂. Similarly to the example of FIG. 27, the communication device 2B changes the transmission direction of the second scan signal LS_{2B} from the upper left irradiation range of the second scan range RS₂ as a start point toward the right side in the horizontal direction. When the transmission direction of the second scan signal LS_{2B} reaches the irradiation range at the right end of the second scan range RS₂, the communication device 2B moves the transmission direction of the second scan signal LS_{2B} to the irradiation range at the left end of the second scan range RS₂. As described above, while changing the transmission direction of the second scan signal LS_{2B}, the communication device 2B specifies the accurate direction of the communication target.

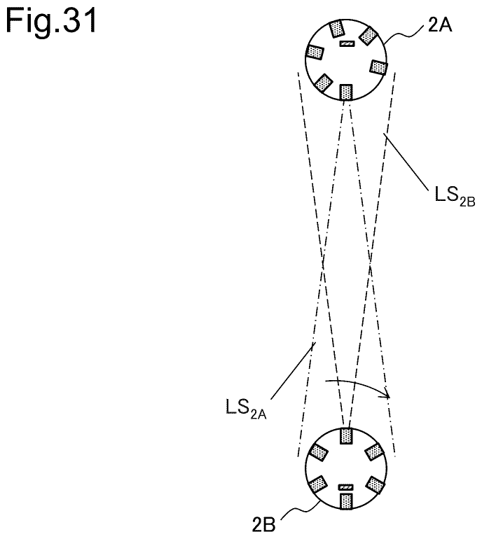

FIG. 31 is a conceptual diagram illustrating a state in which the communication device 2A and the communication device 2B identify an accurate position of a communication target using the second scan signal LS₂. The communication device 2A specifies an accurate position of the communication target by the second scan signal LS_{2A}. Similarly, the communication device 2B specifies an accurate position of the communication target by the second scan signal LS_{2B}.

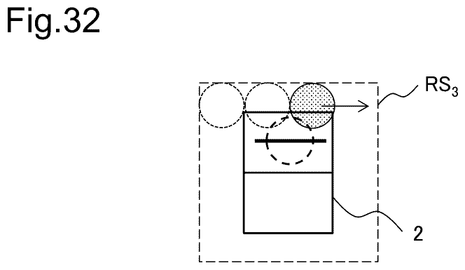

FIG. 32 is a conceptual diagram illustrating an example in which the communication device 2 shifts from the second scan mode to the third scan mode and scans the position of the communication target in detail. In the third scan mode, the irradiation range and the scan range (third scan range RS₃) of the spatial light signal (scan signal) are set to be smaller in area than those in the second scan mode. In the third scan mode, the communication device 2 transmits a spatial light signal (third scan signal) used for a detailed third scan. The irradiation range of the third scan signal is smaller in area than the irradiation ranges of the first scan signal and the second scan signal. For example, the irradiation range of the third scan signal is set to the same area as the irradiation range of the spatial light signal (communication signal) for communication.

For example, in the third scan mode, the communication device 2 transmits a third scan signal including position information indicating the position of the communication device 2 itself toward the direction specified in the second scan mode. The communication target that has received the third scan signal can specify the position of the communication device 2 that is the transmission source of the third scan signal. With this configuration, the two communication devices 2 can accurately specify the positions of each other according to the position information included in the third scan signal.

For example, in the third scan mode, the communication device 2 transmits the third scan signal including an address in the transmission direction toward the direction specified in the second scan mode. The communication target that has received a third scan signal can specify the transmission direction of the spatial light signal (third scan signal) by the communication device 2 that is the transmission source of the third scan signal. The communication target that has received the third scan signal transmits a third scan signal including information on a transmission direction of the third scan signal to the communication device 2 that is a transmission source of the third scan signal. With this configuration, the communication device 2 can determine to which address the third scan signal transmitted from the communication device 2 is received by the communication target in response to reception of the information related to the transmission direction of the third scan signal transmitted from the communication device 2 itself That is, the communication device 2 can specify that the communication target is located in the direction of the address sent back from the communication target.

When the position of the communication target is accurately specified in the third scan mode, the communication device 2 shifts to the communication mode. The communication mode is a mode in which spatial light signals (communication signals) modulated for communication are transmitted and received to and from a communication target for which communication is established, and mutual communication is performed. In the communication mode, optical space communication using a communication signal is performed between the communication devices 2 with which communication has been established. A method of the optical space communication in the communication mode is not particularly limited.

### [Application Example]

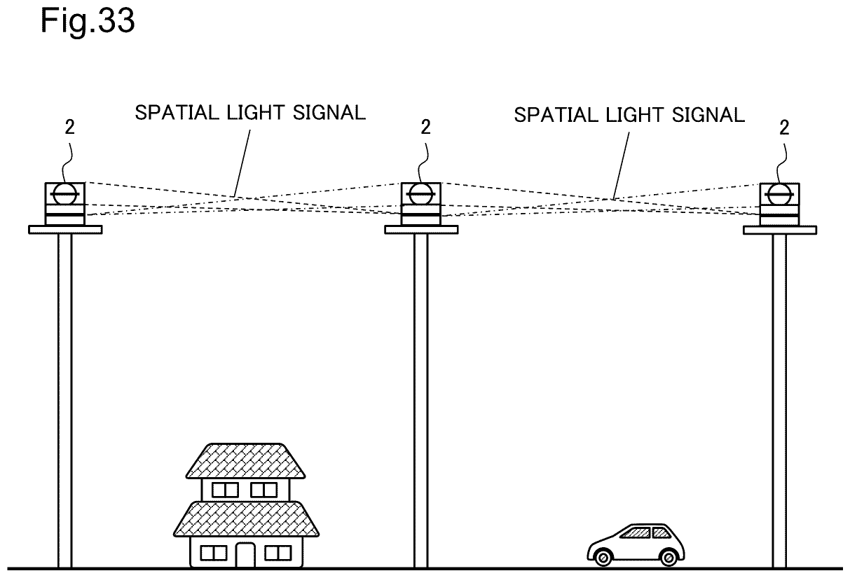

Next, an application example of the present example embodiment will be described with reference to the drawings. In the following application example, an example in which a plurality of communication devices 2 transmit and receive spatial light signals will be described. FIG. 33 is a conceptual diagram for explaining the present application. In the present application example, an example (communication system) of a communication network in which a plurality of communication devices 2 are disposed on an upper portion (space above a pole) of a pole such as a utility pole or a street lamp disposed in a town will be described.

There are few obstacles in the space above the pole. Therefore, the space above the pole is suitable for installation of the communication device 2. If the communication device 2 is installed at the same height, the arrival direction of the spatial light signal is limited to the horizontal direction. Therefore, since the reception area of the light receiving unit 220 constituting the reception device 20 can be reduced, the device can be downsized. The pair of communication devices 2 transmitting and receiving the spatial light signal is disposed at a position where at least one communication device 2 can receive the spatial light signal transmitted from the other communication device 2. The pair of communication devices 2 may be disposed to transmit and receive spatial light signals to and from each other. In a case where a communication network of spatial light signals is configured by a plurality of communication devices 2, the communication device 2 positioned in the middle may be configured to relay a spatial light signal transmitted from another communication device 2 to another communication device 2.

According to the present application example, it is possible to perform optical space communication using a spatial light signal among the plurality of communication devices 2 disposed in the space above the pole. For example, in addition to the optical space communication between the communication devices 2, communication by radio communication using radio waves may be performed between the communication device 2 and a radio device or a base station installed in an automobile, a house, or the like. For example, the communication device 2 may be connected to the Internet via a communication cable or the like installed on a pole.

As described above, the communication device according to the present example embodiment includes the reception device, the transmission device, and the communication control device. The reception device has a configuration of a receiver of the reception device according to the first example embodiment. The transmission device has a plurality of transmission units that transmit spatial light signals. For example, the transmission device includes a phase modulation-type spatial light modulator. The communication control device controls the reception device and the transmission device. The communication control device has a function of a communication control unit of the reception device according to the first example embodiment.

In the reception device included in the communication device of the present example embodiment, the plurality of second light receiving elements disposed on the outer peripheral side surface of the second annular body receives spatial light signals arriving from various directions. The reception device of the present example embodiment detects the arrival direction of the spatial light signal according to the pattern of the intensity of the spatial light signal received by the plurality of second light receiving elements. Therefore, according to the present example embodiment, by accurately detecting the arrival directions of the spatial light signals arriving from various directions, it is possible to achieve a communication device that can flexibly cope with the reception situation of the spatial light signals.

A communication system according to an aspect of the present example embodiment includes a plurality of the above-described communication devices. In a communication system, a plurality of communication devices are disposed to transmit and receive spatial light signals to and from each other. According to the present aspect, it is possible to achieve a communication network that transmits and receives a spatial light signal.

### Third Example Embodiment

Next, a reception device according to a third example embodiment will be described with reference to the drawings. The light-reception device of the present example embodiment has a configuration in which the light-reception devices of the first and second example embodiments are simplified. The reception device of the present example embodiment has a configuration in which the communication control unit is omitted from the reception devices of the first and second example embodiments.

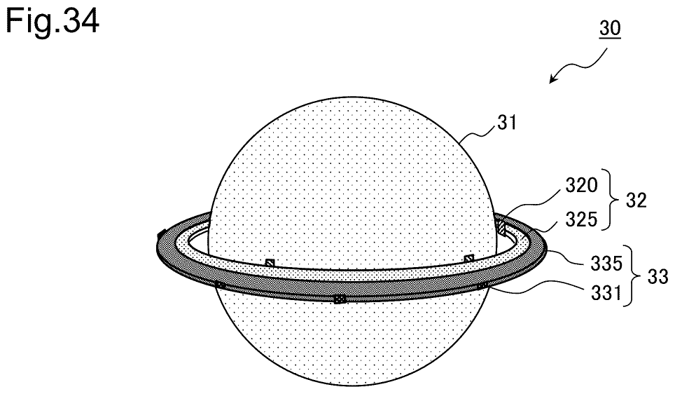

FIG. 34 is a conceptual diagram illustrating an example of a configuration of a reception device 30 according to the present example embodiment. FIG. 34 is a diagram of the reception device 30 viewed from an obliquely upper side.

The reception device includes a ball lens, a first light receiver, and a second light receiver. The ball lens is a spherical lens. The first light receiver includes a first annular body and a plurality of light receiving units. The first annular body surrounds the periphery of the ball lens. The light receiving unit includes a plurality of first light receiving elements disposed on an inner peripheral side surface of the first annular body. The plurality of first light receiving elements are disposed on the inner peripheral side surface of the first annular body with the light receiving part facing the ball lens. The second light receiver includes a second annular body and a plurality of second light receiving elements. The second annular body surrounds the outer periphery of the first annular body. The plurality of second light receiving elements are disposed on the outer peripheral side surface of the second annular body. The plurality of second light receiving elements are disposed on the outer peripheral side surface of the second annular body with the light receiving part facing in a direction opposite to the ball lens.

In the reception device of the present example embodiment, the plurality of second light receiving elements disposed on the outer peripheral side surface of the second annular body receives spatial light signals arriving from various directions. By analyzing the pattern of the intensity of the spatial light signal received by the plurality of second light receiving elements, the arrival direction of the spatial light signal can be accurately detected. Therefore, according to the reception device of the present example embodiment, the arrival directions of spatial light signals arriving from various directions can be accurately detected.

### Hardware

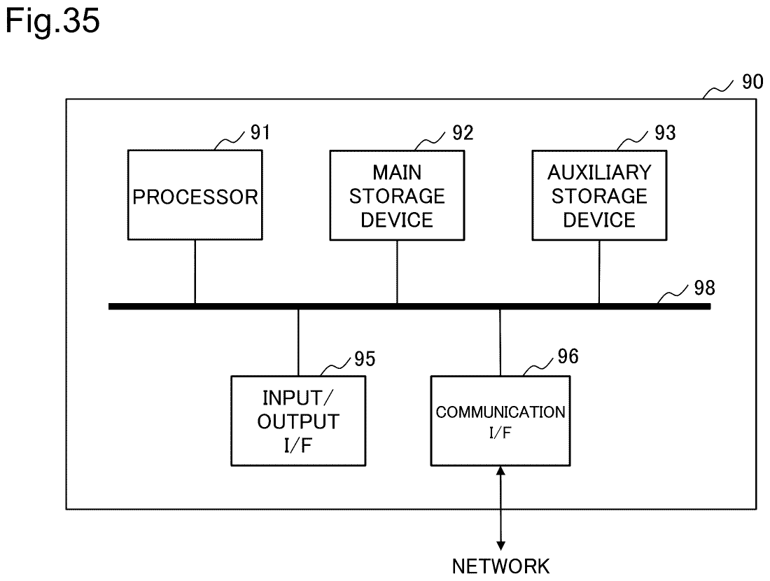

Next, a hardware configuration for executing control and processing according to each example embodiment of the present disclosure will be described with reference to the drawings. Here, an example of such a hardware configuration is an information processing device 90 (computer) in FIG. 35. The information processing device 90 in FIG. 35 is a configuration example for executing the control and processing of each example embodiment, and does not limit the scope of the present disclosure.

As illustrated in FIG. 35, the information processing device 90 includes a processor 91, a main storage device 92, an auxiliary storage device 93, an input/output interface 95, and a communication interface 96. In FIG. 35, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing of each example embodiment. The processor 91 executes the program developed in the main storage device 92. The processor 91 executes the control and processing according to each example embodiment by executing the program.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing according to each example embodiment of the present invention. The hardware configuration of FIG. 35 is an example of a hardware configuration for executing the control and processing of each example embodiment, and does not limit the scope of the present invention. A program for causing a computer to execute the control and processing according to each example embodiment is also included in the scope of the present invention.

Further, a program recording medium in which the program according to each example embodiment is recorded is also included in the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be arbitrarily combined. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A reception device comprising:
a ball lens;
a first light receiver including a first annular body surrounding a periphery of the ball lens and a plurality of light receiving units including a plurality of first light receiving elements disposed on an inner peripheral side surface of the first annular body; and
a second light receiver including a second annular body surrounding an outer periphery of the first annular body and a plurality of second light receiving elements disposed on an outer peripheral side surface of the second annular body, wherein
the plurality of first light receiving elements are disposed on an inner peripheral side surface of the first annular body with a light receiving part facing the ball lens, and
the plurality of second light receiving elements are disposed on an outer peripheral side surface of the second annular body with a light receiving part facing in a direction opposite to the ball lens.

2. The reception device according to claim 1, wherein
the plurality of second light receiving elements are disposed at equal intervals on an outer peripheral side surface of the second annular body.

3. The reception device according to claim 2, wherein
the plurality of light receiving units are disposed to be movable along a circumferential direction of the first annular body.

4. The reception device according to claim 3, further comprising:
a communication control unit including
a direction detection circuit that detects an arrival direction of a spatial light signal according to a pattern of intensity of the spatial light signal received by the plurality of second light receiving elements,
a control circuit that associates any one of the plurality of light receiving units with the spatial light signal of which an arrival direction has been detected, and moves a position of the light receiving unit in such a way that a light receiving surface of the light receiving unit associated with the spatial light signal faces an arrival direction of the spatial light signal, and
a reception circuit that decodes optical signals received by the plurality of first light receiving elements included in the light receiving unit associated with the spatial light signal.

5. The reception device according to claim 4, wherein
the direction detection circuit includes
a plurality of detection circuits that are associated with any of the plurality of second light receiving elements, integrate a signal derived from the spatial light signal received by the associated second light receiving element, and separate the integrated signal into frequencies of communication targets, and
a direction determination circuit that determines an arrival direction of the spatial light signal according to a profile of the signal for each frequency separated by the plurality of detection circuits.

6. The reception device according to claim 5, wherein
the detection circuit includes
an integration circuit that integrates the signal derived from the spatial light signal received by the associated second light receiving element,
a converter that converts the signal integrated by the integration circuit into a digital signal, and
a digital filter that separates the signal converted into a digital signal by the converter into frequencies of the communication targets.

7. A communication device comprising:
a reception device according to claim 1;
a transmission device that includes a plurality of transmission units that transmit spatial light signals; and
a communication control device comprises
a memory storing instructions, and
a processor connected to the memory and configured to execute the instructions to
control the reception device and the transmission device.

8. The communication device according to claim 7, wherein
the processor of the communication control device is configured to execute the instructions to
change a transmission direction of the spatial light signal transmitted from the transmission device toward an arrival direction of a spatial light signal detected by the reception device.

9. The communication device according to claim 8, wherein
the processor of the communication control device is configured to execute the instructions to
detect an arrival direction of the spatial light signal relevant to the optical signal based on an optical signal received by the plurality of second light receiving elements included in a second light receiver included in the reception device; and
specify an accurate position of a communication target by transmitting and receiving the spatial light signal to and from the communication target that is a transmission source of the spatial light signal based on an optical signal received by the plurality of first light receiving elements included in a first light receiver included in the reception device.

10. A communication system comprising:
a plurality of the communication devices according to claim 9, wherein
the plurality of the communication devices are disposed to transmit and receive spatial light signals to and from each other.
